(19) United States
(12) Patent Application Publication
(10) Pub. No.: US 2026/0368868 A1
(43) Pub. Date: Nov. 19, 2026

(54) ELECTRONIC DEVICE AND METHOD FOR ACQUIRING METADATA OF IMAGE

(71) Applicant: Samsung Electronics Co., Ltd., Suwon-si (KR)

(72) Inventors: Seoyoung LEE, Suwon-si (KR); Unggyu KIM, Suwon-si (KR); Minwoo LEE, Suwon-si (KR); Donghwy KIM, Suwon-si (KR); Kwangtai KIM, Suwon-si (KR); Donghyun YEOM, Suwon-si (KR)

(21) Appl. No.: 19/723,849

(22) Filed: Jun. 29, 2026

Related U.S. Application Data
(63) Continuation of application No. PCT/KR2024/018781, filed on Nov. 25, 2024.

(30) Foreign Application Priority Data
Jan. 2, 2024 (KR) 10-2024-0000595
Jan. 17, 2024 (KR) 10-2024-0007360

(51) Int. Cl. G06T 5/92; G06T 7/11

(52) U.S. Cl. CPC G06T 5/92; G06T 7/11; G06T 2207/20208

(57) ABSTRACT

An electronic device is provided. The electronic device includes a display, memory, including one or more storage media, storing instructions, at least one processor including processing circuitry communicatively coupled to the display and the memory, wherein the instructions, when executed by the at least one processor individually or collectively, cause the electronic device to, based on a predetermined event, obtain a single image, when the single image is displayed for a first area of the single image that is visually highlighted for a second area of the single image, obtain map information from the single image for changing a gradation range of the first area from a first gradation range to a second gradation range wider than the first gradation range, and store a file including metadata including the map information and the single image, in the memory

### CROSS-REFERENCE TO RELATED APPLICATION(S)

This application is a continuation application, claiming priority under 35 U.S.C. § 365 (c), of an International application No. PCT/KR2024/018781, filed on Nov. 25, 2024, which is based on and claims the benefit of a Korean patent application number 10-2024-0000595, filed on Jan. 2, 2024, in the Ministry of Intellectual Property (MOIP), and of a Korean patent application number 10-2024-0007360, filed on Jan. 17, 2024, in the Ministry of Intellectual Property (MOIP), the disclosure of each of which is incorporated by reference herein in its entirety.

### BACKGROUND

### 1. Field

The disclosure relates to an electronic device and a method for obtaining metadata of an image.

### 2. Description of Related Art

Digital information generated to visualize an image, and/or a video (e.g., an image file having a format of a joint photographic experts group (JPEG), and/or a moving picture experts group (MPEG)) may be generated to indicate a color by using a limited number of bits. For example, in the digital information, brightness of a specific primary color (e.g., any one primary color among red, green, or blue) may be stored by using 8 bits. In the example, the digital information may be generated to indicate the brightness of the specific primary color by using brightness levels of a total of 256 steps (=2⁸).

The above information is presented as background information only to assist with an understanding of the disclosure. No determination has been made, and no assertion is made, as to whether any of the above might be applicable as a prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for obtaining metadata of an image.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, at least one processor including processing circuitry communicatively coupled to the display and the memory, wherein the instructions, when executed by the at least one processor individually or collectively, cause the electronic device to, based on a predetermined event, obtain a single image, when the single image is displayed for a first area of the single image that is visually highlighted for a second area of the single image, obtain map information from the single image for changing a gradation range of the first area from a first gradation range to a second gradation range wider than the first gradation range, and store a file including metadata including the map information and the single image, in memory.

In accordance with another aspect of the disclosure, a method performed by an electronic device including a display is provided. The method includes, based on a predetermined event, obtaining a single image, when the single image is displayed for a first area of the single image that is visually highlighted for a second area of the single image, obtaining map information from the single image for changing a gradation range of the first area from a first gradation range to a second gradation range wider than the first gradation range, and storing a file including metadata including the map information and the single image, in memory.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include, based on a predetermined event, obtaining a single image, when the single image is displayed for a first area of the single image that is visually highlighted for a second area of the single image, obtaining map information from the single image for changing a gradation range of the first area from a first gradation range to a second gradation range wider than the first gradation range, and storing a file including metadata including the map information and the single image, in the memory.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an operation of an electronic device for displaying a screen from a single image according to an embodiment of the disclosure;

FIG. 2 illustrates a block diagram of an electronic device according to an embodiment of the disclosure;

FIG. 3 illustrates a flowchart for an operation of an electronic device according to an embodiment of the disclosure;

FIG. 4 illustrates an operation of an electronic device for distinguishing a first area and a second area according to an embodiment of the disclosure;

FIG. 5 illustrates a structure of a file generated by an electronic device according to an embodiment of the disclosure;

FIG. 6 illustrates an operation of an electronic device for obtaining map information according to an embodiment of the disclosure;

FIG. 7A illustrates an operation of an electronic device for performing a flattening process according to an embodiment of the disclosure;

FIG. 7B illustrates a detailed operation of an electronic device for performing a flattening process according to an embodiment of the disclosure;

FIG. 7C illustrates a gain image is changed according to a flattening process according to an embodiment of the disclosure;

FIG. 8 illustrates a detailed operation of an electronic device for performing a filtering process according to an embodiment of the disclosure;

FIG. 9A illustrates a detailed operation of an electronic device for performing a gradation range setting process according to an embodiment of the disclosure;

FIG. 9B illustrates a change of an image according to a gradation range setting process according to an embodiment of the disclosure;

FIG. 10A illustrates an operation of an electronic device for changing a gradation range according to an embodiment of the disclosure;

FIG. 10B illustrates a change of an image according to a change of a gradation range according to an embodiment of the disclosure;

FIG. 10C illustrates a change of an image according to a change of a gradation range according to an embodiment of the disclosure;

FIG. 11 is a block diagram of an electronic device in a network environment according to an embodiment of the disclosure;

FIG. 12 is a block diagram illustrating a camera module according to various embodiments of the disclosure; and

FIG. 13 is a block diagram of a display module according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents

It is to be understood that the singular forms “a,” “an,” and “the” include a plural referents unless the context clearly dictates otherwise. Thus, for example, reference to “a component surface” includes reference to one or more of such surfaces.

In the document, an expression, such as “A or B”, “at least one of A and/or B”, “A, B or C”, or “at least one of A, B and/or C”, and the like may include all possible combinations of items listed together. Expressions, such as “1^{st}”, “2^{nd}”, “first” or “second”, and the like may modify the corresponding components regardless of order or importance, are only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the document may include a unit configured with hardware or firmware, and may be used interchangeably with terms, such as logic, block, component, or circuit, and the like. The module may be an integrally configured component or a minimum unit or part thereof that performs one or more functions. For example, a module may be configured with an application-specific integrated circuit (ASIC).

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

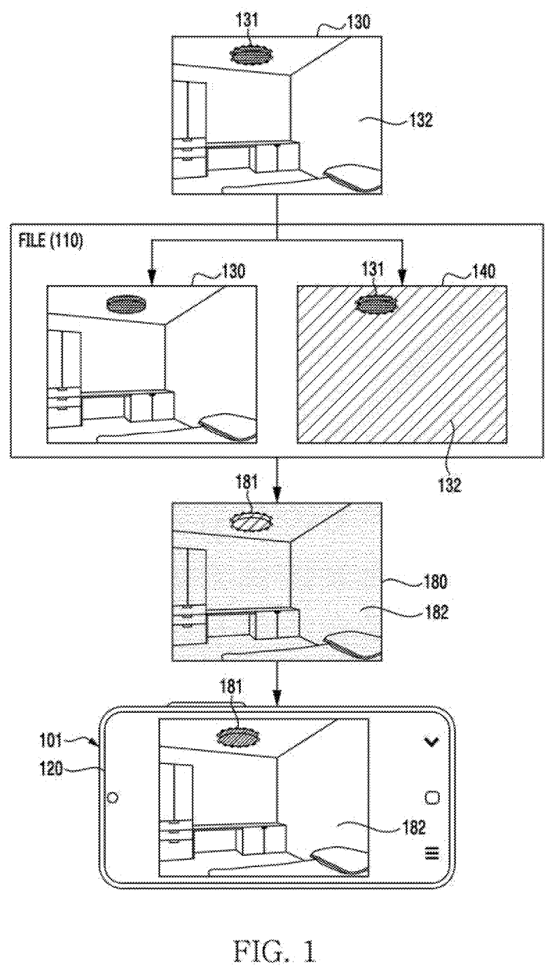

FIG. 1 illustrates an operation of an electronic device for displaying a screen from a single image according to an embodiment of the disclosure.

Referring to FIG. 1, an electronic device 101 may have form factors of various forms, such as a smartphone, a laptop personal computer (PC), a tablet PC, a head-mounted display (HMD) device, a watch, and other similar computing devices (not illustrated). The electronic device 101 may be referred to as a mobile device, a user terminal, a user equipment (UE), a multi-functional device, a portable communication device, and/or a portable device. The form factor of the electronic device 101 is not limited to form factors illustrated in FIG. 1.

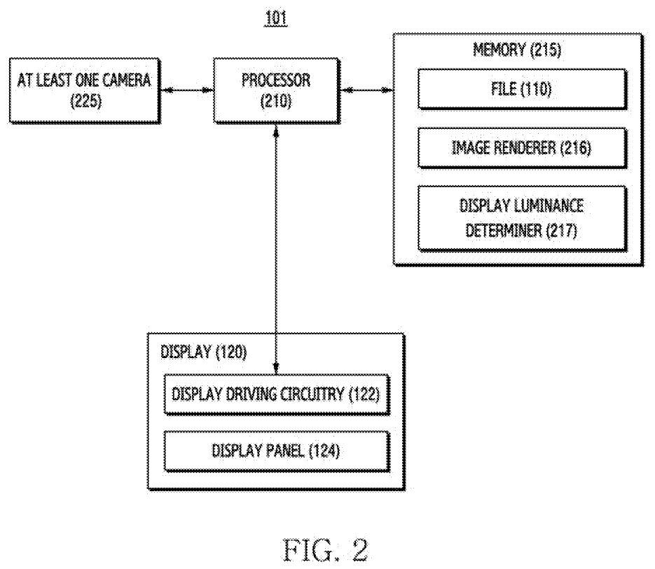

In an embodiment of the disclosure, the electronic device 101 may generate a file 110, and/or may visualize, or may display media content (e.g., media content referred to as a photo, and/or an image) of the generated file 110. The file 110 may include a JPEG file, a high efficiency image file format (HEIF) file, a high efficiency image container (HEIC) file, a portable network graphic (PNG) file, and/or a graphics interchange format (GIF) file. An hardware configuration of the electronic device 101 for executing a function related to generation and/or processing of the file 110 is described with reference to FIG. 2.

In the disclosure, luminance may mean intensity of light emitted from pixels of a display 120 (e.g., intensity of light measured in units of nit (or cd/m2)). In the disclosure, a brightness value of the display 120 may mean brightness (or luminance) provided from the display 120. The brightness value of the display 120 and a brightness value of an image may be distinguished. In the disclosure, the brightness value (or, a luma value, a brightness level, a gray scale value) of the image may mean a relative value indicated according to a designated number of bit depths, referred to as a brightness level, as a digital value assigned to a pixel of the image. For example, the brightness value of the image may include a Y value (or a gray scale value) in a YUV color space.

In the disclosure, a dynamic range of the image may mean a range of brightness of pixels of the image. Each of the pixels of the image having a standard dynamic range (SDR) may have any one value among 256 steps (=2⁸) of brightness levels by using a bit depth of 8 bits. For example, when displaying the image having the SDR, the electronic device 101 may control the display 120 by using brightness values (or luma values) of the pixels of the image. For example, the electronic device 101 may control the display 120 such that each of the pixels of the display 120 outputs light of any one luminance among luminances corresponding to the 256 steps of brightness levels. The SDR may represent, for example, a color of a standard RGB (sRGB) color space. When displaying the image having the SDR, a ratio (hereinafter, contrast ratio) between minimum luminance and maximum luminance of the pixels of the display 120 may be about 250:1 (or about 256:1). The minimum luminance and the maximum luminance may have a difference of about 100 nit.

According to an embodiment of the disclosure, the electronic device 101 may perform an operation related to a dynamic range (e.g., high dynamic range (HDR)) wider than the SDR. For example, the electronic device 101 may change a contrast ratio of the display 120 to a contrast ratio (e.g., 1,000:1, 10,000:1, and/or 20,000:1) exceeding the above-described 250:1 by controlling the display 120 supporting an HDR mode. For example, in a case that the display 120 operates in the HDR mode, a luminance difference between pixels of a dark portion and a bright portion of the image displayed through the display 120 may be increased.

Referring to FIG. 1, the electronic device 101 may obtain a first image 130. For example, the first image 130 may be an image. The first image 130 may be referred to as a single image. The first image 130 may be obtained based on a predetermined event.

For example, the predetermined event may include an event for obtaining a plurality of images by using at least one camera of the electronic device 101. The predetermined event may include an input for shooting an external environment by using the at least one camera. The first image 130 may be obtained based on the plurality of images obtained through the at least one camera. The plurality of images may have different exposure values. Each of the plurality of images may have different dynamic ranges. The electronic device 101 may obtain (or generate) the first image 130 having a gradation range regarding the SDR by synthesizing (e.g., bracketing) the plurality of images. For example, the first image 130 may include brightness values indicated according to a bit depth of 8 bits. As an example, the gradation range of the first image 130 may mean a range of the brightness values of the first image 130 indicated according to the bit depth of 8 bits. The gradation range of the first image 130 may mean a range for displaying brightness values of pixels of the first image 130 indicated according to the bit depth of 8 bits. As an example, each of the brightness values of the pixels of the first image 130 may correspond to any one of 256 brightness levels. The gradation range of the first image 130 may be set from a brightest first level among the brightness levels of the pixels of the first image 130 to a darkest second level among the brightness levels of the pixels of the first image 130. According to an embodiment of the disclosure, the predetermined event may include a user input for displaying the first image 130 through the display 120.

According to an embodiment of the disclosure, the electronic device 101 may identify setting information of the first image 130. The electronic device 101 may identify a first area 131 and a second area 132 based on the setting information of the first image 130. For example, the setting information of the first image 130 may include information regarding the at least one camera for obtaining the first image 130, a shooting mode of the first image 130, or information regarding at least one object included in the first image 130.

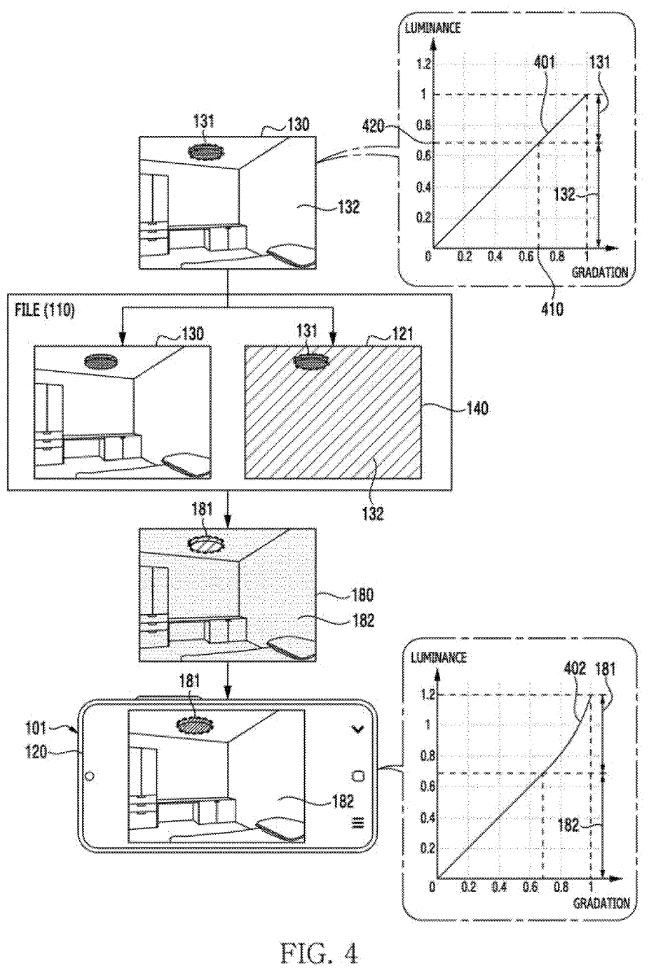

The electronic device 101 may determine at least one gradation level based on the setting information of the first image 130. The at least one gradation level may be used for distinguishing the first area 131 and the second area 132. The first area may have a first gradation range. The second area may have a third gradation range distinguished from the first gradation range. An example of an operation of the electronic device 101 for distinguishing the first area 131 and the second area 132 based on the at least one gradation level will be described below in FIG. 4.

The electronic device 101 may obtain map information 140 based on removing the second area 132 (or brightness values of the second area 132 or data of the second area 132) from the first image 130. For example, the map information 140 may be used for changing the first gradation range of the first area 131 to a second gradation range wider than the first gradation range. The electronic device 101 may store the file 110 including the first image 130 and the map information 140 in memory of the electronic device 101. For example, the map information 140 may be referred to as a gain map. For example, the first image 130 may be configured based on the bit depth of 8 bits. The map information 140 may also be configured based on the bit depth of 8 bits. An operation of the electronic device 101 for obtaining the map information 140 will be described below in the drawings described below.

For displaying the first image 130 on a screen, the electronic device 101 may obtain (or configure) a second image 180 based on the file 110 including the first image 130 and the map information 140. The electronic device 101 may obtain the second image 180 based on the first image 130 and the map information 140. The second image 180 may include a third area 181 corresponding to the first area 131 and a fourth area 182 corresponding to the second area 132.

The third area 181 of the second image 180 may be set to be brighter than the first area 131 of the first image 130. The fourth area 182 of the second image 180 may be set to be darker than the second area 132 of the first image 130. The electronic device 101 may identify a brightness value of the display 120 based on the first image 130 and the map information 140. For displaying the first image 130, the electronic device 101 may display the second image 180 configured based on the first image 130 and the map information 140 by using the display 120 providing brightness according to the identified brightness value.

For example, the fourth area 182 of the second image 180 may be set to be darker than the second area 132 of the first image 130. In a case that the fourth area 182 of the second image 180 is displayed darker than the second area 132 of the first image 130, a user may feel a sense of heterogeneity. Accordingly, the electronic device 101 may identify a brightness value of the display 120 in which luminance of the fourth area 182 of the second image 180 is set to be identical or similar to luminance of the second area 132 of the first image 130. The electronic device 101 may increase the brightness value of the display 120 such that the luminance of the fourth area 182 of the second image 180 and the luminance of the second area 132 of the first image 130 are identical or similar. As the brightness value of the display 120 is increased, the third area 181 of the second image 180 may become brighter. Accordingly, the user of the electronic device 101 may recognize that the second area 132 of the first image 130 is maintained and the first area 131 of the first image 130 is displayed brighter.

In the following description, an operation of the electronic device 101 for obtaining, from the first image 130, the map information 140 for changing a gradation range of the first area 131 from the first gradation range to the second gradation range wider than the first gradation range will be described.

FIG. 2 illustrates a block diagram of an electronic device according to an embodiment of the disclosure.

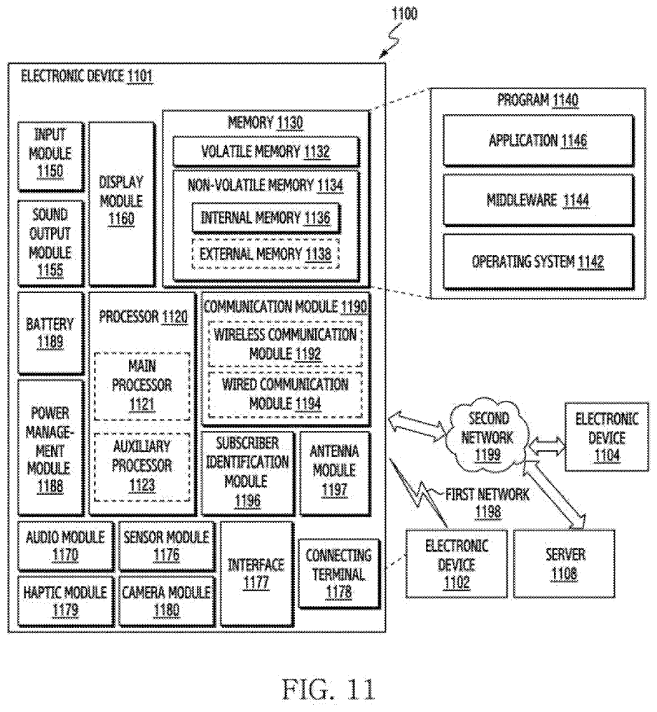

Referring to FIG. 2, an electronic device 101 may include a processor 210 (e.g., a processor 1120 of FIG. 11), a display 120, memory 215, and at least one camera 225. A hardware configuration of the electronic device 101 is not limited to an embodiment of FIG. 2. For example, the electronic device 101 may further include an electronic component described with reference to FIG. 11. For example, a portion (e.g., the at least one camera 225) of electronic components of FIG. 2 may be excluded from the electronic device 101.

For example, the processor 210 may be operably or operatively coupled with the display 120 or display driving circuitry 122 in the display 120. For example, the processor 210 being operably coupled with the display 120 (or the display driving circuitry 122) may indicate that the processor 210 is directly connected with the display 120 (or the display driving circuitry 122). For example, the processor 210 being operably coupled with the display 120 (or the display driving circuitry 122) may indicate that the processor 210 is connected with the display 120 (or the display driving circuitry 122) through another component of the electronic device 101. For example, the processor 210 being operably coupled with the display 120 (or the display driving circuitry 122) may indicate that a state of the processor 210 is a state capable of controlling the display 120 (or the display driving circuitry 122). For example, the processor 210 being operably coupled with the display 120 (or the display driving circuitry 122) may indicate that an operation of the display 120 (or the display driving circuitry 122) is caused based on information, data, a signal, or a command obtained from the processor 210. However, it is not limited thereto.

For example, the processor 210 of the electronic device 101 may include circuitry (e.g., processing circuitry) for processing data based on one or more instructions. The circuitry for processing data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). For example, the number of processors may be one or more. Processing circuitry of a processor that loads (or fetches) an instruction and performs calculation corresponding to the loaded instruction may be referred to as, or may be referenced as, core circuitry (or a core). For example, the processor may have a structure of a multi-core processor including a plurality of core circuits, such as a dual core, a quad core, a hexa core, or an octa core. A function and/or an operation described with reference to the disclosure may be performed individually or collectively by one or more processing circuits included in the processor 210.

For example, the display 120 of the electronic device 101 may output visualized information (e.g., a screen) to a user. For example, the display 120 may output the visualized information to the user by being controlled by a controller, such as a graphic processing unit (GPU). The display 120 may include a liquid crystal display (LCD), a plasma display panel (PDP), and/or one or more light emitting diodes (LEDs). The LEDs may include an organic LED (OLED). The display 120 may include a flat panel display (FPD) and/or electronic paper. An embodiment is not limited thereto, and the display 120 may have an at least partially curved form or may have a deformable form. The display 120 having the deformable form may be referred to as a flexible display.

For example, the display 120 of the electronic device 101 may include a sensor (e.g., a touch sensor panel (TSP)) for detecting an external object (e.g., a finger of the user) on the display 120. For example, based on the TSP, the processor 210 may detect an external object contacting the display 120 or floating on the display 120. In response to detecting the external object, the processor 210 may execute a function related to a specific visual object corresponding to a location of the external object on the display 120 among visual objects being displayed on the display 120.

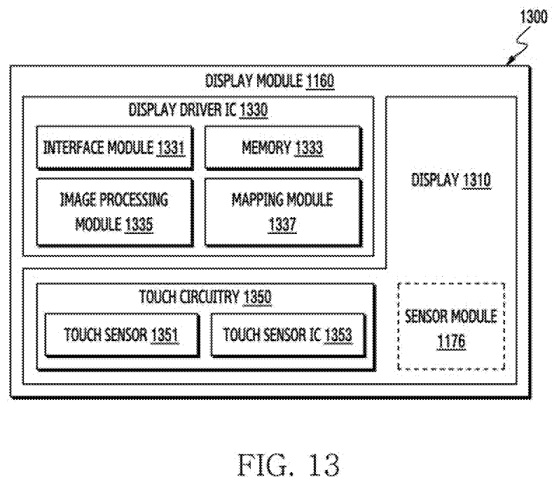

For example, the display 120 may include the display driving circuitry 122 (e.g., display driver IC 1330 of FIG. 13) and a display panel 124 (e.g., a display 1310 of FIG. 13). For example, the display driving circuitry 122 may be operably coupled with the display panel 124. For example, in a case that the display panel 124 includes a plurality of LEDs arranged in a two-dimensional matrix form, the display driving circuitry 122 may be configured to control at least one LED included in a corresponding row or column among the plurality of LEDs. The display driving circuitry 122 controlling the at least one LED may include an operation of adjusting luminance (or a light amount, brightness) of the LEDs. In the disclosure, luminance may mean intensity of light emitted from pixels of the display 120 (e.g., intensity of light measured in units of nit (or cd/m2)). For example, a brightness value of the display 120 may mean a maximum value of the luminance.

For example, the memory 215 of the electronic device 101 may include circuitry and/or a storage medium for storing data and/or an instruction input to and/or output from the processor 210. The memory 215 may include, for example, volatile memory, such as random-access memory (RAM) and/or non-volatile memory, such as read-only memory (ROM). The non-volatile memory may be referred to as storage. The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, hard disk, compact disc, solid state drive (SSD), and embedded multi media card (eMMC). The processor 210 of the electronic device 101 may execute instructions of the memory 215 in the electronic device 101 to perform a function and/or an operation indicated by the instructions. For example, in a case that the electronic device 101 includes at least one processor, the at least one processor may be configured to execute the instructions collectively or individually.

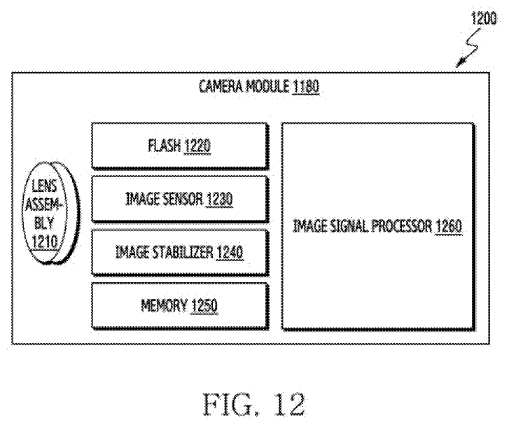

For example, the at least one camera 225 of the electronic device 101 may include one or more optical sensors (e.g., a charged coupled device (CCD) sensor and a complementary metal oxide semiconductor (CMOS) sensor) that generate an electrical signal indicating a color and/or brightness of light. A plurality of optical sensors included in the at least one camera 225 may be disposed in a form of a two-dimensional array. The at least one camera 225 may generate two-dimensional frame data corresponding to light reaching the optical sensors of the two-dimensional array by obtaining electrical signals of each of the plurality of optical sensors substantially simultaneously. For example, photo data captured using the at least one camera 225 may mean a two-dimensional frame data obtained from the at least one camera 225. For example, video data captured using the at least one camera 225 may mean a sequence of a plurality of two-dimensional frame data obtained from the at least one camera 225. The at least one camera 225 of FIG. 2 may include a camera module 1180 of FIG. 11 and/or FIG. 12.

Referring to FIG. 2, information (e.g., a file 110) and/or programs (e.g., an image renderer 216 and/or a display luminance determiner 217) stored in the memory 215 of the electronic device 101 are illustrated. The processor 210 executing instructions included in a program may perform a function and/or an operation indicated by the instructions. The file 110 may include color information indicating colors of pixels of an image (e.g., the first image 130 of FIG. 1) according to a color space, such as YUV, RGB, and/or HSV. For example, the file 110 based on a color space of RGB may indicate a color of a specific pixel by using intensities of three primary colors of red, green, and blue. For example, the file 110 based on a color space of YUV may indicate a color of a specific pixel by using three components including a brightness component (e.g., a Y component) and color difference components (e.g., a Cb component and/or a Cr component).

For example, at least three channels may be used to indicate colors of pixels of an image. From the file 110 of a JPEG format, the processor 210 may identify colors of a plurality of pixels, represented by three channels having a bit depth of 8 bits. The file 110 may additionally include map information (e.g., the map information 140 of FIG. 1) corresponding to a specific component (e.g., a brightness component). The map information corresponding to the specific component may be used for increasing (e.g., the number of bits greater than 8 bits) a bit depth of the specific component.

By executing the image renderer 216, the processor 210 may generate, or may synthesize, an image (e.g., the second image 180 of FIG. 1) having an HDR effect from an image (e.g., the first image 130 of FIG. 1) having SDR included in the file 110. For example, the processor 210 may restore the image having the HDR effect from the image having the SDR by using the map information (e.g., the map information 140 of FIG. 1) included in metadata of the file 110. The restoration may include scaling (e.g., amplification and/or attenuation) brightnesses of pixels of the image having the SDR by using information included in the map information. The processor 210 executed the image renderer 216 may generate, or may obtain, information for displaying an image having a contrast ratio of HDR.

By executing the display luminance determiner 217, the processor 210 may at least partially increase luminance of pixels of the display 120. The processor 210 executed the display luminance determiner 217 may at least partially increase luminance of the display 120 by controlling the display driving circuitry 122. For example, in order to visually highlight a portion of an image to be displayed on the display 120 with respect to another portion, the processor 210 may make luminance of at least one pixel of the display 120 corresponding to the portion exceed luminance of at least one pixel of the display 120 corresponding to the another portion. For example, the processor 210 may set luminance of at least one pixel of the display 120 corresponding to a portion (e.g., a portion to be highlighted or the first area 131 of FIG. 1) of the image to be displayed on the display 120 to be brighter than luminance of at least one pixel of the display 120 corresponding to another portion (e.g., a portion excluding the portion to be highlighted or the second area 132 of FIG. 1) of the image.

The processor 210 executed the display luminance determiner 217 may adjust gamma of an image rendered by the image renderer 216. The gamma may mean a relationship between brightness of pixels of an image and luminance of a pixel of the display 120 displaying the image. The gamma may be represented as a function referred to as a gamma curve. When displaying an image (e.g., the second image 180 of FIG. 1) synthesized from the file 110, the processor 210 may control the display driving circuitry 122 to display the image by using gamma related to metadata (e.g., the map information 140) of the file 110.

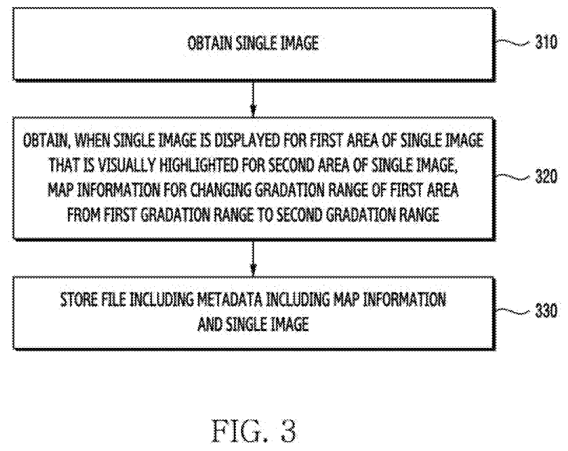

FIG. 3 illustrates a flowchart for an operation of an electronic device according to an embodiment of the disclosure. In the following embodiment of the disclosure, each operation may be performed sequentially, but is not necessarily performed sequentially. For example, an order of each operation may be changed, and at least two operations may be performed in parallel.

Referring to FIG. 3, in operation 310, a processor 210 may obtain a single image (e.g., the first image 130 of FIG. 1). For example, the processor 210 may obtain the single image based on a predetermined event.

For example, the predetermined event may include an event for obtaining a plurality of images by using at least one camera 225 of an electronic device 101. The predetermined event may include an input for shooting an external environment by using the at least one camera 225. The single image may be obtained based on the plurality of images. Each of the plurality of images may have different dynamic ranges. The electronic device 101 may obtain (or generate) the single image having a gradation range regarding SDR by synthesizing (e.g., bracketing) the plurality of images.

For example, the predetermined event may include an event for obtaining a single image having one exposure value by using one camera. For example, before performing 8-bit image signal processing (ISP), the processor 210 may apply a tone mapping operator (TMO) to a Bayer pattern. The processor 210 may maximize a dynamic range of the single image and, in a case that brightness of a subject area is different, may map gradation to distinguish and represent this. The processor 210 may obtain the single image according to the above-described example. According to an embodiment of the disclosure, the predetermined event may include a user input for displaying the single image on a display 120.

For example, the single image may be configured based on a bit depth of 8 bits. The single image may include brightness values indicated according to the bit depth of 8 bits. A gradation range of the single image may mean a range of the brightness values of the single image indicated according to the bit depth of 8 bits. The gradation range of the single image may be set from a brightest first level among brightness levels of pixels of the single image to a darkest second level among the brightness levels of the pixels of the single image.

In operation 320, the processor 210 may obtain, when the single image is displayed for a first area of the single image that is visually highlighted for a second area of the single image, map information for changing a gradation range of the first area from a first gradation range to a second gradation range. For example, the second gradation range may be wider than the first gradation range.

According to an embodiment of the disclosure, the processor 210 may distinguish the first area and the second area in the single image. For example, the processor 210 may determine at least one gradation level based on setting information regarding the single image. The processor 210 may identify the first area and the second area in the single image based on the at least one gradation level. The at least one gradation level may be used for distinguishing the first area and the second area.

For example, the setting information regarding the single image may include at least one of information regarding the at least one camera 225 for obtaining the single image, a shooting mode (e.g., a portrait shooting mode, a food shooting mode, a night view shooting mode, or a text shooting mode) regarding the single image, or information regarding at least one object included in the single image. According to an embodiment of the disclosure, the processor 210 may determine the at least one gradation level based on capability information (or setting information) of the display 120 and/or capability information (or setting information) of the at least one camera 225 as well as the setting information regarding the single image.

For example, the at least one gradation level may include a threshold gradation level. The processor 210 may identify a gradation range exceeding the threshold gradation level as the first gradation range. The first area may have a gradation range (or the first gradation range) exceeding the threshold gradation level. The second area may have a gradation range (or a third gradation range) equal to or less than the threshold gradation level.

For example, the first area may be referred to as a high-luminance area. The second area may be referred to as a low-luminance area. For example, the first area may be referred to as an HDR area. The second area may be referred to as an SDR area.

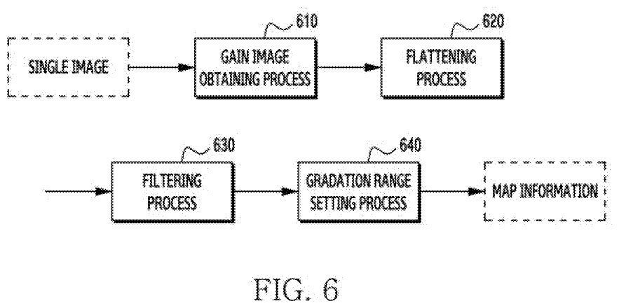

According to an embodiment of the disclosure, the processor 210 may obtain a gain image including the first area by removing the second area (or brightness values of the second area or data of the second area) from the single image. The processor 210 may obtain map information based on the gain image. The processor 210 may obtain the map information based on the gain image by using a designated algorithm and/or a designated filter. For example, the processor 210 may remove distortion of the gain image by using the designated algorithm and/or the designated filter. The processor 210 may obtain the map information based on removing the distortion of the gain image. The map information may be the gain image calibrated by using the designated algorithm and/or the designated filter. An example of an operation of the processor 210 for obtaining the map information based on the gain image by using the designated algorithm and/or the designated filter will be described below in FIGS. 6, 7A, 7B, 7C, 8, 9A, and 9B. According to an embodiment of the disclosure, the gain image may correspond to the map information. For example, the map information may be the gain image.

For example, the map information may be used for changing the gradation range of the first area to the second gradation range wider than the first gradation range. The processor 210 may configure another image based on the single image and the map information. As an example, in a case that the gradation range of the first area is changed from the first gradation range to the second gradation range, a brightness value of at least a portion of pixels included in the first area may be increased. The processor 210 may obtain the map information for changing the gradation range of the first area from the first gradation range from 30 to 200 to the second gradation range from 30 to 250.

According to an embodiment of the disclosure, the processor 210 may identify that a designated object (e.g., a face of a person (or a user)) is included in the single image. The processor 210 may reduce the second gradation range based on identifying that the designated object (e.g., the face of the person (or the user)) is included in the single image. The processor 210 may obtain the map information for changing the gradation range of the first area from the first gradation range to the reduced second gradation range.

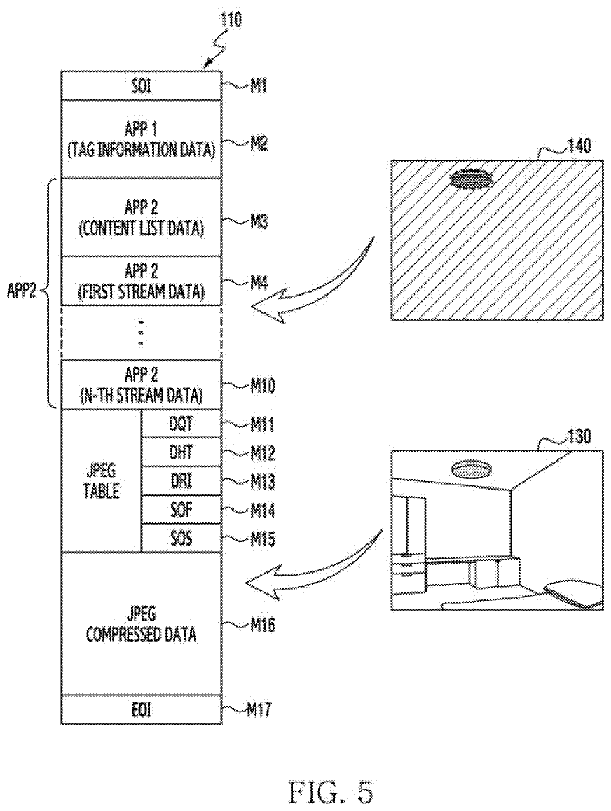

In operation 330, the processor 210 may store a file (e.g., the file 110 of FIG. 1) including metadata including the map information and the single image. For example, a detailed example of the file including the metadata and the single image will be described below in FIG. 5.

According to an embodiment of the disclosure, the processor 210 may display the single image through the display 120 based on the file including the metadata including the map information and the single image. For example, the processor 210 may identify a brightness value of the display 120 based on the metadata and the single image. For displaying the single image, the processor 210 may display another image configured based on the metadata and the single image by using the display 120 providing brightness according to the identified brightness value.

For example, the processor 210 may identify a user input for displaying the single image. The processor 210 may configure another image based on the single image and the metadata. The processor 210 may identify the brightness value of the display 120 based on the single image and the metadata. The processor 210 may display the another image using the display 120 providing brightness according to the identified brightness value. By displaying the another image, the processor 210 may provide the first area of the single image to the user by highlighting the first area. The user of the electronic device 101 may recognize (or identify) the another image in which the first area of the single image is highlighted compared to the single image.

FIG. 4 illustrates an operation of an electronic device for distinguishing a first area and a second area according to an embodiment of the disclosure.

Referring to FIG. 4, a graph 401 indicates a normalized luminance level according to a normalized gradation level regarding a first image 130. A graph 402 indicates a normalized luminance level according to a normalized gradation level regarding a second image 180.

The processor 210 may identify a threshold gradation level 410. For example, the processor 210 may identify setting information of the first image 130. The processor 210 may identify the threshold gradation level 410 based on the setting information of the first image 130. The processor 210 may identify a first area 131 and a second area 132 based on the threshold gradation level 410. The processor 210 may distinguish the first image 130 into the first area 131 and the second area 132 based on the threshold gradation level 410.

For example, the threshold gradation level 410 may be set to a gradation level at which a contour does not occur when the second image 180 is displayed on a display 120.

For example, the processor 210 may identify a threshold luminance level 420 according to the threshold gradation level 410. The processor 210 may identify the first area 131 and the second area 132 based on the threshold luminance level 420. The processor 210 may distinguish the first image 130 into the first area 131 and the second area 132 based on the threshold luminance level 420.

In FIG. 4, an example in which the first area 131 and the second area 132 are distinguished based on the threshold gradation level 410 is illustrated, but is not limited thereto. The processor 210 may identify a plurality of threshold gradation levels. For example, the processor 210 may identify a first threshold gradation level and a second threshold gradation level. The processor 210 may identify the first area having a gradation range between the first threshold gradation level and the second threshold gradation level. The processor 210 may identify a remaining area excluding the first area as the second area. The processor 210 may set the first area based on a characteristic of the first image 130 (or a characteristic of at least one visual object included in the first image 130).

According to an embodiment of the disclosure, the processor 210 may distinguish the first area 131 and the second area 132 to obtain map information. The processor 210 may obtain a gain image 121 in which the second area 132 is excluded from the first image 130. The processor 210 may obtain the map information 140 based on the gain image 121. The processor 210 may obtain the second image 180 based on the first image 130 and the map information 140. The processor 210 may change a gradation range of the first area 131 of the first image 130 from a first gradation range to a second gradation range wider than the first gradation range. The processor 210 may obtain the second image 180 in which the gradation range of the first area 131 is changed from the first gradation range to the second gradation range. The processor 210 may display the second image 180 by using the display 120.

For example, the first image 130 may be configured based on a bit depth of 8 bits. The gain image 121 (or the map information 140) may also be configured based on the bit depth of 8 bits. The second image 180 may also be configured based on the bit depth of 8 bits. As an example, the processor 210 may obtain the second image 180 configured based on the bit depth of 8 bits by using the first image 130 configured based on the bit depth of 8 bits and the map information 140 configured based on the bit depth of 8 bits. The processor 210 may compress (or reduce) a bit depth of the first image 130 from 8 bits to 7 bits. The processor 210 may compress (or reduce) a bit depth of the map information 140 from 8 bits to 7 bits. The processor 210 may obtain the second image 180 configured based on the bit depth of 8 bits by performing a combination of the first image 130 and the map information 140.

For example, the second image 180 displayed through the display 120 may include a third area 181 and a fourth area 182. The third area 181 of the second image 180 may correspond to the first area 131 of the first image 130. The fourth area 182 of the second image 180 may correspond to the second area 132 of the first image 130. The fourth area 182 of the second image 180 displayed through the display 120 may be displayed identically or similarly to the second area 132 of the first image 130. The third area 181 of the second image 180 displayed through the display 120 may be visually highlighted compared to the first area 131 of the first image 130.

For example, a luminance level for the third area 181 of the second image 180 may be set to be greater than a luminance level for the first area 131 of the first image 130. The processor 210 may change the gradation range of the first area to the second gradation range wider than the first gradation range by combining the first image 130 and the map information 140. As the gradation range of the first area 131 is changed to the second gradation range, the luminance level for the third area 181 of the second image 180 may be set to be greater than the luminance level for the first area 131 of the first image 130. Accordingly, the processor 210 may display, through the display 120, the second image 180 in which the first area 131 of the first image 130 is visually highlighted with respect to the second area 132.

According to an embodiment of the disclosure, in the first image 130, in a case that a normalized gradation level is ‘1’ (or a gradation level is 255), a brightness value (or luminance) of the display 120 may be set to 300 nit. In the second image 180, in a case that the normalized gradation level is ‘1’ (or the gradation level is 255), the brightness value (or the luminance) of the display 120 may be set to 360 nit. The graph 401 and the graph 402 are exemplary and are not limited thereto. The graph 402 may be changed according to setting information (or user setting, setting of the display 120). For example, in the first image 130, in a case that the normalized gradation level is ‘1’ (or the gradation level is 255), the brightness value (or the luminance) of the display 120 may be set to 300 nit. In the second image 180, in a case that the normalized gradation level is ‘1’ (or the gradation level is 255), the brightness value (or the luminance) of the display 120 may also be set to 2000 nit.

For example, in the first image 130, in a case that the normalized gradation level is ‘1’, a normalized luminance level of the display 120 may be set to ‘1’. In the second image 180, in a case that the normalized gradation level is ‘1’, the normalized luminance level of the display 120 may be set to ‘1.2’. As the second image 180 is displayed through the display 120 instead of the first image 130, the luminance level may be changed from ‘1’ to ‘1.2’. A ratio at which the luminance level is changed may be changed according to an embodiment of the disclosure. The ratio at which the luminance level is changed may be referred to as an SDR-to-HDR ratio.

According to an embodiment of the disclosure, the gradation range of the first area 131 may be rearranged through a gamma curve. For example, the gamma curve may include a hybrid log gamma (HLG) curve and/or a perceptual quantization (PQ) curve. According to an embodiment of the disclosure, the processor 210 may set a gamma curve applied to the first gradation range of the first area 131 differently from a gamma curve applied to a third gradation range of the second area 132.

According to the above-described embodiment of the disclosure, the processor 210 may restore the second image 180, which is an image having an HDR effect, by rearranging luminance information disposed in the first image 130, which is an SDR image, through TMO. The processor 210 may store the first area 131, which is a high-luminance area included in the first image 130, as the map information 140. The processor 210 may map and display the third area 181 corresponding to the first area 131 with high luminance through the display 120 by using the map information 140.

FIG. 5 illustrates a structure of a file generated by an electronic device according to an embodiment of the disclosure.

Referring to FIG. 5, a structure of a file 110 based on a format of an international standardization organization (ISO), referred to as an exchangeable image file (EXIF), is illustrated. The file 110 stored in memory (e.g., the memory 215 of FIG. 2) may start from a segment M1 in which a designated value (e.g., a value of Table 1 below) for indicating start of image of the file 110 is stored. After the segment M1, application segments (APP) (e.g., M2, M3, M4, . . . , M10) may be formed in the file 110.

Tag information may be stored in a first application segment M2 of the file 110. The tag information may include one or more character strings used for indexing of the file 110. Content list data M3 and/or stream data M4 to M10 may be stored in a second application segment APP2 of the file 110. In the file 110, after application segments M2, M3, . . . , M10, JPEG table segments M11, M12, . . . , M15 may be formed. The JPEG table segments may include a define-quantization-tables (DQT) segment M11 (e.g., a variable segment starting with a value of Table 1 below), a define-Huffman-Tables (DHT) segment M12 (e.g., a variable segment starting with a value of Table 1 below), a define-restart-interval (DRI) segment M13 (e.g., a fixed segment starting with a value of Table 1 below), a start of frame (SOF) segment M14, and/or a start-of-scan (SOS) segment M15 (e.g., a variable segment starting with a value of Table 1 below). In the file 110, after the JPEG table segments, a JPEG compressed data segment M16 may be formed. The file 110 may include, after the JPEG compressed data segment M16, a segment M17 in which a designated value for indicating end of image of the file 110 is stored (e.g., a fixed segment starting with a value of Table 1 below).

In an embodiment of the disclosure, information stored in the file 110 based on a format of EXIF is not limited to the example of FIG. 5. For example, the file 110 may include information having a name of Table 1.

TABLE 1

| | Value in | | |
|---|---|---|---|
| | file 110 | Length of | |
| Abbre- | (hexadecimal- | information | |
| viation | based) | (or payload) | Name |
| SOI | 0xFF, 0xD8 | None | Start point of image |
| SOF0 | 0xFF, 0xC0 | Variable | Start point of frame (baseline |
| | | | discrete cosine transform |
| | | | (DCT)) |
| SOF2 | 0xFF, 0xC2 | Variable | Start point of frame |
| | | | (progressive DCT) |
| DHT | 0xFF, 0xC4 | Variable | Definition of Huffman table |
| DQT | 0xFF, 0xDB | Variable | Definition of quantization |
| | | | table |
| DRI | 0xFF, 0xDD | 4 bytes | Definition of restart interval |
| SOS | 0xFF, 0xDA | Variable | Start point of scan |
| RSTn | 0xFF, 0xDn | None | Restart point |
| | (n = 0, | | |
| | . . . , 7) | | |
| APPn | 0xFF, 0xEn | Variable | Application segment (EXIF, |
| | | | APP1, and the like) |
| COM | 0xFF, 0xFE | Variable | Comment |
| EOI | 0xFF, 0xD9 | None | End point of image |

According to an embodiment of the disclosure, the single image may be stored in the JPEG compressed data segment M16 in the file 110. For example, the first image 130 may be stored in the JPEG compressed data segment M16 in the file 110. Metadata may be stored in another segment (e.g., M2 to M10) of the file 110 different from the JPEG compressed data segment M16. For example, the map information 140 used for restoring and/or displaying an image having an HDR effect may be stored in the second application segment APP2 of the file 110.

Although not illustrated, according to an embodiment of the disclosure, the map information 140 may also be stored in a metadata segment of an extensible metadata platform (XMP).

Hereinafter, an example of a detailed operation of an electronic device 101 (or a processor 210) for obtaining metadata (e.g., map information) from the single image will be described.

FIG. 6 illustrates an operation of an electronic device for obtaining map information according to an embodiment of the disclosure.

Referring to FIG. 6, a processor 210 may obtain map information (e.g., the map information 140 of FIG. 1) by using a single image (e.g., the first image 130 of FIG. 1). For example, the processor 210 may obtain the map information by using the single image by performing a gain image obtaining process 610, a flattening process 620, a filtering process 630, and/or a gradation range correction process 640. The processor 210 may obtain the map information for changing a gradation range of a first area in the single image from a first gradation range to a second gradation range wider than the first gradation range.

According to an embodiment of the disclosure, the processor 210 may perform the gain image obtaining process 610 by using the single image. The processor 210 may distinguish the single image into the first area (e.g., the first area 131 of FIG. 1) and a second area (e.g., the second area 132 of FIG. 1). For example, the processor 210 may determine at least one gradation level based on setting information regarding the single image. The processor 210 may distinguish the first area and the second area in the single image based on the at least one gradation level.

For example, the processor 210 may identify a threshold gradation level included in the at least one gradation level. The processor 210 may identify a gradation range exceeding the threshold gradation level as the first gradation range. The processor 210 may identify a gradation range equal to or less than the threshold gradation level as a third gradation range. The processor 210 may identify the first area having the first gradation range. The processor 210 may identify the second area having the third gradation range.

For example, the processor 210 may obtain a gain image by excluding the second area in the single image. The processor 210 may obtain the gain image having data for the first area among the single image. In a case that operations 620 to 640 are not performed, the gain image may be referred to (or identified) as the map information.

After the gain image is obtained, the processor 210 may perform the flattening process 620, the filtering process 630, and/or the gradation range correction process 640. In FIG. 6, the flattening process 620, the filtering process 630, and the gradation range correction process 640 are illustrated as being sequentially performed, but are not limited thereto. An order in which the flattening process 620, the filtering process 630, and the gradation range correction process 640 are performed may be changed. According to an embodiment of the disclosure, at least a portion of the flattening process 620, the filtering process 630, and the gradation range correction process 640 may not be performed.

For convenience of description, a target image (or an input image) for the flattening process 620, the filtering process 630, and the gradation range correction process 640 will be described as the gain image. For example, in a case that the filtering process 630 is performed after the flattening process 620 is performed, the target image for the filtering process 630 may be the gain image on which the flattening process 620 is performed. For example, in a case that the flattening process 620 is performed after the gradation range correction process 640 is performed, the target image for the flattening process 620 may be the gain image on which the gradation range correction process 640 is performed.

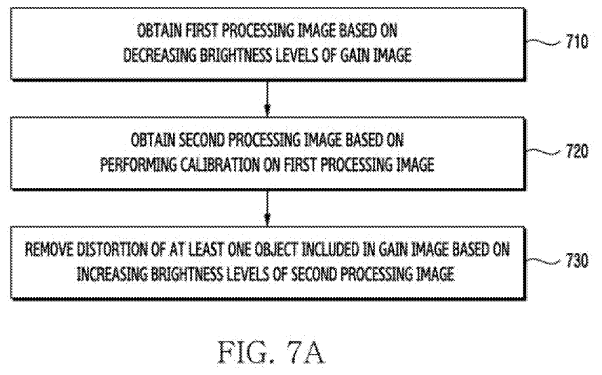

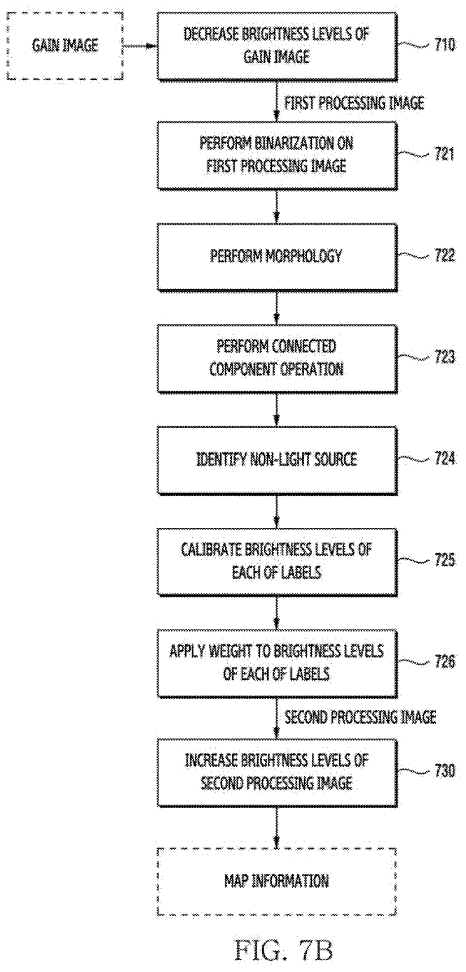

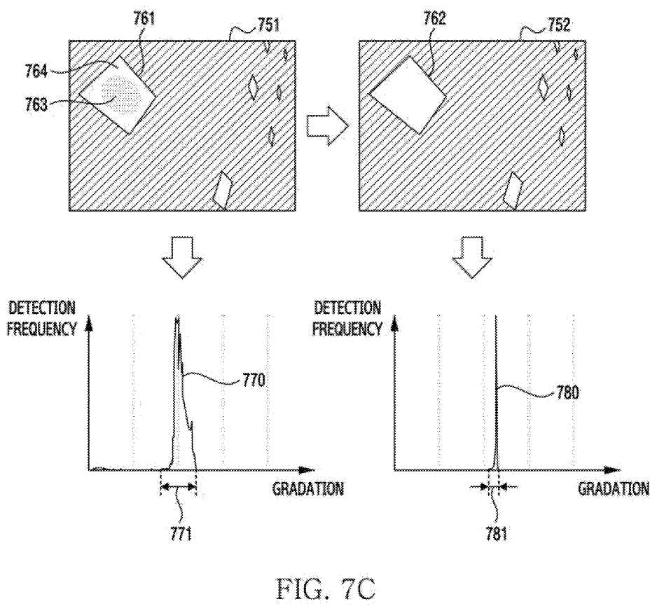

According to an embodiment of the disclosure, the processor 210 may perform the flattening process 620 by using the gain image. For example, the processor 210 may remove distortion of at least one object included in the gain image by using a designated algorithm. An example of a detailed operation of the flattening process 620 will be described below in FIGS. 7A, 7B, and 7C.

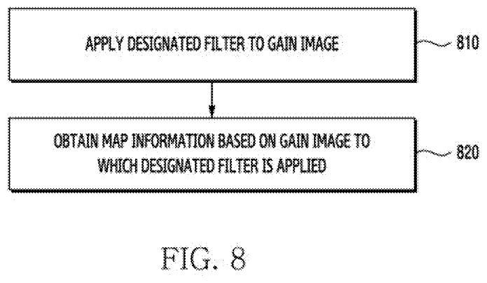

According to an embodiment of the disclosure, the processor 210 may perform the filtering process 630 by using the gain image. The processor 210 may apply a designated filter to the gain image. The processor 210 may remove the distortion of the at least one object while maintaining an outline of the at least one object included in the gain image by applying the designated filter to the gain image. An example of a detailed operation of the filtering process 630 will be described below in FIG. 8.

According to an embodiment of the disclosure, the processor 210 may perform the gradation range correcting process 640 by using the gain image. The processor 210 may identify whether a designated object (e.g., a face of a person) is included in the single image.

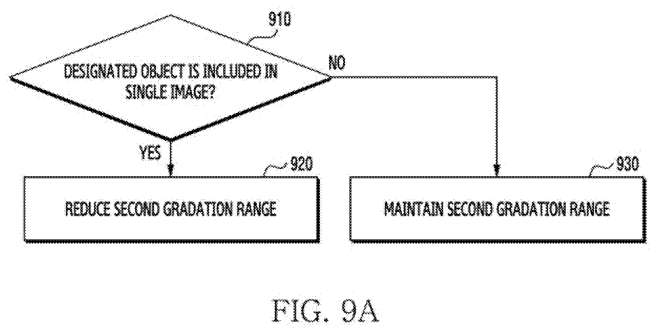

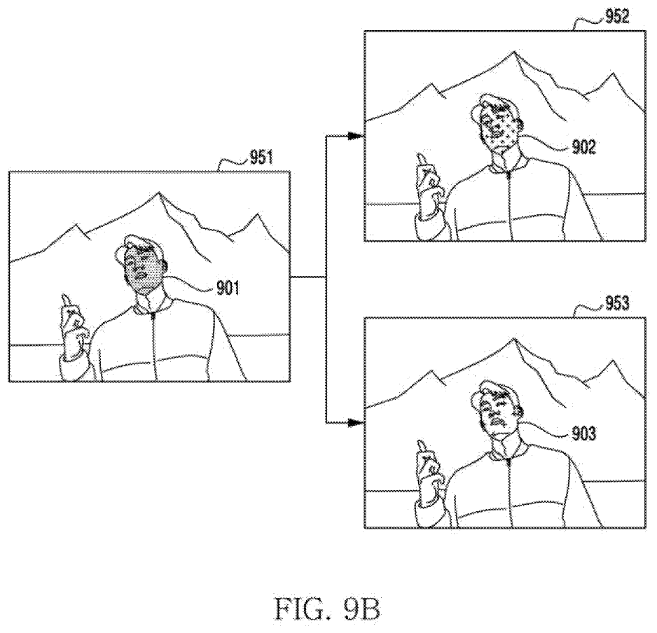

In a case that the designated object (e.g., the face of the person) is included in the single image, the processor 210 may reduce the second gradation range. The processor 210 may configure the map information such that the second gradation range is reduced. The reduced second gradation range may be wider than the first gradation range. In a case that the designated object is not included in the single image, the processor 210 may maintain the second gradation range. The processor 210 may configure the map information such that the second gradation range is maintained. An example of a detailed operation of the gradation range correcting process 640 will be described below in FIGS. 9A and 9B.

According to the above-described embodiment of the disclosure, the processor 210 may obtain the map information from the single image by performing at least one of the gain image obtaining process 610, the flattening process 620, the filtering process 630, and/or the gradation range correction process 640. The processor 210 may obtain (or configure), based on the single image and the map information, another image including a first area visually highlighted for a second area. For example, the processor 210 may change a gradation range of the first area from a first gradation range to a second gradation range wider than the first gradation range. The processor 210 may obtain (or configure) the another image by changing the gradation range of the first area from the first gradation range to the second gradation range wider than the first gradation range. The processor 210 may identify a brightness value of a display 120 based on the single image and the map information. The processor 210 may display the another image by using the display 120 providing brightness according to the identified brightness value. The processor 210 may visually highlight the first area of the single image for the second area by displaying the another image using the display 120 providing brightness according to the identified brightness value.

FIG. 7A illustrates an operation of an electronic device for performing a flattening process according to an embodiment of the disclosure.

FIG. 7B illustrates of a detailed operation of an electronic device for performing a flattening process according to an embodiment of the disclosure.

FIG. 7C illustrates a gain image is changed according to a flattening process according to an embodiment of the disclosure.

Referring to FIG. 7A, since a gain image is obtained based on a threshold gradation value, the gain image may include noise and/or distortion. A processor 210 may remove the noise and/or the distortion of the gain image by performing operation 710 to operation 730.

In the operation 710, the processor 210 may obtain a first processing image based on decreasing brightness levels of the gain image.

In the operation 720, the processor 210 may obtain a second processing image based on performing a calibration on the first processing image. The processor 210 may obtain the second processing image by calibrating the first processing image. A detailed operation for obtaining the second processing image by calibrating the first processing image will be described below in FIG. 8.

For example, the processor 210 may obtain the second processing image based on reducing and enlarging again a size of the first processing image. As the size of the first processing image is reduced and then enlarged again, at least a portion of the noise and/or the distortion may be removed.

In the operation 730, the processor 210 may remove distortion of at least one object included in the gain image based on increasing brightness levels of the second processing image. The processor 210 may obtain map information from which the distortion is removed by increasing the brightness levels of the second processing image again. For example, in a case that the brightness levels are decreased by ¼ according to the operation 710, the processor 210 may increase the brightness levels by 4 times.

The processor 210 may obtain the map information by removing the distortion of the at least one object included in the gain image according to the operation 710 to the operation 730. For example, the operation 710 to the operation 730 may be performed based on a designated algorithm. In FIG. 8, an operation of the designated algorithm for performing the operation 710 to the operation 730 will be described.

Referring to FIG. 7B, operation 721 to operation 726 may be an example of the operation 720 of FIG. 7A.

In the operation 710, the processor 210 may decrease brightness levels of the gain image based on the gain image. The processor 210 may obtain the first processing image based on decreasing the brightness levels of the gain image. The operation 710 may correspond to the operation 710 of FIG. 7A.

In the operation 721, the processor 210 may perform binarization on the first processing image. The processor 210 may set a brightness level to a first value (e.g., ‘1’) based on the brightness level exceeding a designated brightness level. The processor 210 may set the brightness level to a second value (e.g., ‘0’) based on the brightness level being equal to or less than the designated brightness level. The processor 210 may perform the binarization by setting each of brightness values of pixels of the first processing image to one of the first value and the second value.

In the operation 722, the processor 210 may perform morphology. The processor 210 may reduce noise (e.g., a misidentified light source) based on decreasing and increasing again a size of an image on which the operation 721 is performed. For example, the processor 210 may reduce the noise (e.g., the misidentified light source) based on performing dilation and/or erosion of the image on which the operation 721 is performed, according to the morphology.

In the operation 723, the processor 210 may perform a connected component operation. The processor 210 may set labels of objects in the image on which the operation 722 is performed based on performing the connected component operation. The processor 210 may obtain a label map of the objects included in the image on which the operation 722 is performed based on performing the connected component operation. According to an embodiment of the disclosure, the processor 210 may perform a calibration on the label map. The processor 210 may perform the calibration on the label map based on an aspect ratio or the size.

In the operation 724, the processor 210 may identify a non-light source. The processor 210 may identify the non-light source based on a statistical value (e.g., an average value or a mean value) of labels included in the label map.

In the operation 725, the processor 210 may calibrate brightness levels of each of the labels. For example, the processor 210 may identify a ceil line (or a maximum value) of brightness levels of the labels included in the label map. The processor 210 may change the brightness levels of the labels to the ceil line (or the maximum value).

In the operation 726, the processor 210 may apply a weight to the brightness levels of each of the labels. The processor 210 may apply the weight to the brightness levels of each of the labels based on at least one of flatness regarding the brightness levels of each of the labels, an average value of the brightness levels, and/or a gradation change amount. The processor 210 may obtain the second processing image by performing the operation 726.

In the operation 730, the processor 210 may increase brightness levels of the second processing image. The processor 210 may remove the noise and/or the distortion included in the gain image by increasing the brightness levels of the second processing image again. The processor 210 may obtain the map information based on removing the noise and/or the distortion included in the gain image.

Referring to FIG. 7C, the processor 210 may convert an image 751 into an image 752 based on a flattening process (e.g., the flattening process 620 of FIG. 6).

For example, the image 751 may be an example of the gain image. The image 752 may be an example of the map information.

The image 751 may include at least one object including an object 761. The object 761 may indicate an external object (e.g., a fluorescent lamp). Even in a case that the object 761 indicates the same external object, a gradation range of the object 761 may be configured to be wider than a designated gradation range. In a case that the gradation range is wide, the object 761 may be displayed in a blotchy form. For example, gradation levels of an area 763 of the object 761 and gradation levels of an area 764 may be distinguished. In a case that the gradation levels of the area 763 and the gradation levels of the area 764 are distinguished, the object 761 indicating the same object may be displayed in the blotchy form. Accordingly, the processor 210 may perform a flattening process to change the gradation range of the object 761 to be narrow.

A graph 770 indicates a detection frequency according to gradation levels of the object 761. The object 761 may have gradation levels of a gradation range 771. The processor 210 may perform a flattening process on the image 751. The processor 210 may obtain the image 752 based on the flattening process. For example, the processor 210 may obtain the image 752 by changing the object 761 to an object 762. A graph 780 indicates a detection frequency according to gradation levels of the object 762. The object 762 may have gradation levels of a gradation range 781. The gradation range 781 may be narrower than the gradation range 771.

The processor 210 may obtain the object 762 having identical or similar gradation levels by changing the gradation range of the object 761 to be narrow through the flattening process. In a case that the gradation levels of the object 762 are configured to be identical or similar, the object 762 indicating the same object may not be displayed in a blotchy form.

According to the above-described embodiment of the disclosure, as internal contrast of a highlight area (e.g., the object 761) is increased, a user may recognize that blotchy distortion occurs in the highlight area. The processor 210 may perform flattening such that the user does not recognize the blotchy distortion by decreasing the internal contrast of the highlight area.

FIG. 8 illustrates a detailed operation of an electronic device for performing a filtering process according to an embodiment of the disclosure.

Referring to FIG. 8, in operation 810, a processor 210 may apply a designated filter to a gain image. For example, the processor 210 may apply the designated filter to the gain image to remove distortion of at least one object included in the gain image while maintaining an outline of the at least one object included in the gain image. For example, the designated filter may include a guided image filter (GIF). The processor 210 may preserve an edge area of the gain image and flatten a remaining area, based on applying the GIF to the gain image. The processor 210 may remove sparkle distortion in the gain image while preserving a face of a person and/or an outline of an object.

According to an embodiment of the disclosure, a partial area of a reflector may be identified as a high-luminance area. For example, according to a light source characteristic (e.g., intensity or a direction), or a characteristic (e.g., a shape, a size, or material) of the reflector, the partial area of the reflector may be identified as the high-luminance area. In a case that the partial area of the reflector is identified as the high-luminance area, the partial area may be displayed brighter than necessary according to the gamma mapping process described in FIG. 4. As an example, in a case that the face of the person is photographed outdoors, the face may be photographed brightly due to an outdoor light source (e.g., sunlight), and an area corresponding to a ridge of a nose may be identified as the high-luminance area. Accordingly, the area may be identified as the sparkle distortion.

In a case that the partial area of the reflector is identified as the high-luminance area, the processor 210 may apply the designated filter to the gain image. The processor 210 may remove the sparkle distortion by applying the designated filter to the gain image. The processor 210 may remove the sparkle distortion in the gain image while maintaining an outline or an edge area of an object corresponding to the reflector in the gain image.

In operation 820, the processor 210 may obtain map information. For example, the processor 210 may obtain the map information based on the gain image to which the designated filter is applied. The gain image to which the designated filter is applied may be an image from which distortion (e.g., the sparkle distortion) is removed. The processor 210 may obtain the gain image from which the distortion is removed through the designated filter and may obtain the map information from which the distortion is removed by using the obtained gain image.

FIG. 9A illustrates a detailed operation of an electronic device for performing a gradation range setting process according to an embodiment of the disclosure.

FIG. 9B illustrates a change of an image according to a gradation range setting process according to an embodiment of the disclosure.

Referring to FIG. 9A, in operation 910, a processor 210 may identify whether a designated object is included in a single image. For example, the designated object may include a body part (e.g., a face) of a user, a designated object (e.g., food), or objects indicating a designated scene.

The processor 210 may perform an object recognition process on at least one object included in the single image. For example, the processor 210 may perform the object recognition process on the at least one object by using a designated prediction model (e.g., an artificial intelligence model). The processor 210 may set the at least one object as input data of the designated prediction model. The processor 210 may identify a type (or a class) of the at least one object based on output data of the designated prediction model. The processor 210 may identify whether the designated object is included in the single image based on identifying the type of the at least one object.

In operation 920, in a case that the designated object is included in the single image, the processor 210 may reduce a second gradation range. For example, the processor 210 may reduce the second gradation range based on identifying that the designated object is included in the single image. The processor 210 may configure map information such that the second gradation range is reduced.

In operation 930, in a case that the designated object is not included in the single image, the processor 210 may maintain the second gradation range. For example, the processor 210 may maintain the second gradation range based on identifying that the designated object is not included in the single image. The processor 210 may configure map information such that the second gradation range is maintained.

According to the operation 910 to the operation 930, the processor 210 may determine whether to reduce the second gradation range according to whether the designated object is included in the single image. For example, a face of a person may be included in the single image. In a case that an overall brightness level of the face of the person is set to be high, in another image configured based on the single image and the map information, a brightness level of the face of the person may be further increased. The face of the person is a part that a user of an electronic device 101 most sensitively recognizes, and in a case that a brightness change for the face of the person is large, the user may feel a sense of heterogeneity. Accordingly, in a case that the face of the person is included in the single image, by reducing the second gradation range, an increase rate of the brightness level of the single image may be reduced.

Referring to FIG. 9B, the processor 210 may obtain an image 951. The image 951 may be an example of the single image described in FIG. 9A. The processor 210 may obtain an image 952 or 953 configured based on the image 951 and map information obtained from the image 951.

For example, the image 952 may be an image obtained from the map information configured such that the second gradation range is maintained. The image 953 may be an image obtained from the map information configured such that the second gradation range is reduced.

According to an embodiment of the disclosure, the processor 210 may determine at least one gradation level based on setting information regarding the image 951. The processor 210 may identify a first area and a second area based on the at least one gradation level. The processor 210 may identify an area corresponding to a designated object 901 as the first area. The processor 210 may identify an area excluding the area corresponding to the designated object 901 as the second area.

The processor 210 may obtain map information to visually highlight the first area (e.g., the area corresponding to the designated object 901) for the second area. For example, the map information may be used for changing a gradation range of the first area from a first gradation range to a second gradation range wider than the first gradation range.

According to an embodiment of the disclosure, the processor 210 may identify that the designated object 901 is included in the image 951. For example, the designated object 901 may indicate the face of the person. The processor 210 may reduce the second gradation range based on identifying that the designated object 901 is included in the image 951. The reduced second gradation range may be wider than the first gradation range. The processor 210 may obtain map information for changing the gradation range of the first area (e.g., the area corresponding to the designated object 901) from the first gradation range to the reduced second gradation range. The processor 210 may obtain the image 953 based on the image 951 and the map information. Brightness levels regarding an object 903 of the image 953 may be set to be greater than brightness levels regarding the object 901 of the image 951.

According to an embodiment of the disclosure, in a case that the second gradation range is maintained, the processor 210 may obtain map information for changing the gradation range of the first area (e.g., the area corresponding to the designated object 901) from the first gradation range to the maintained second gradation range. The processor 210 may obtain the image 952 based on the image 951 and the map information. Brightness levels regarding an object 902 of the image 952 may be set to be greater than the brightness levels regarding the object 901 of the image 951.

For example, the brightness levels regarding the object 903 of the image 953 may be set to be smaller than the brightness levels regarding the object 902 of the image 952. The processor 210 may reduce the second gradation range based on identifying that the designated object 901 is included in the image 951. As the processor 210 reduces the second gradation range, the processor 210 may reduce, for the designated object 901 in the image 951, an increase rate (or a gain) of the brightness levels regarding the object 902 of the image 952. For example, the processor 210 may display the image 952 through a display 120 by decreasing an overall luminance increase rate of the image 952.

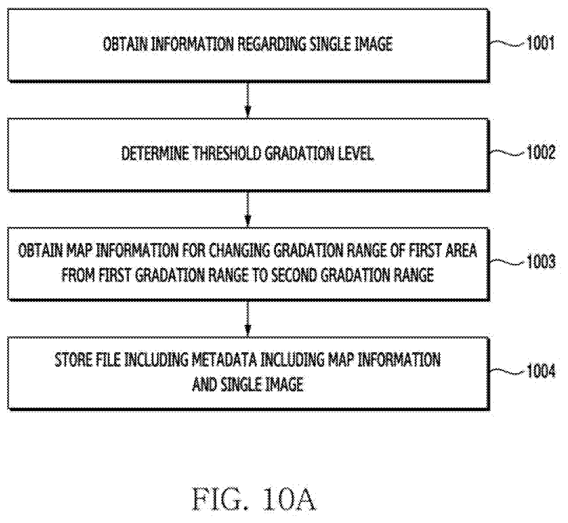

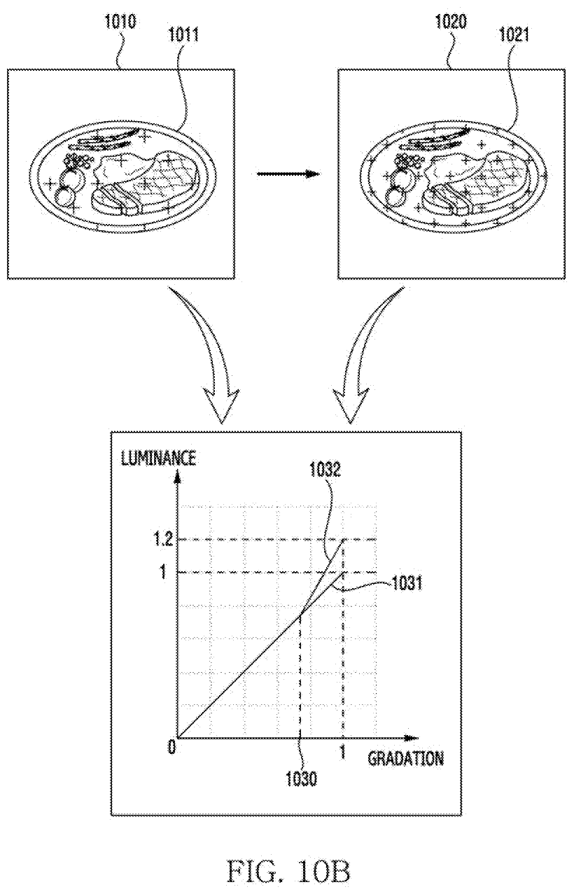

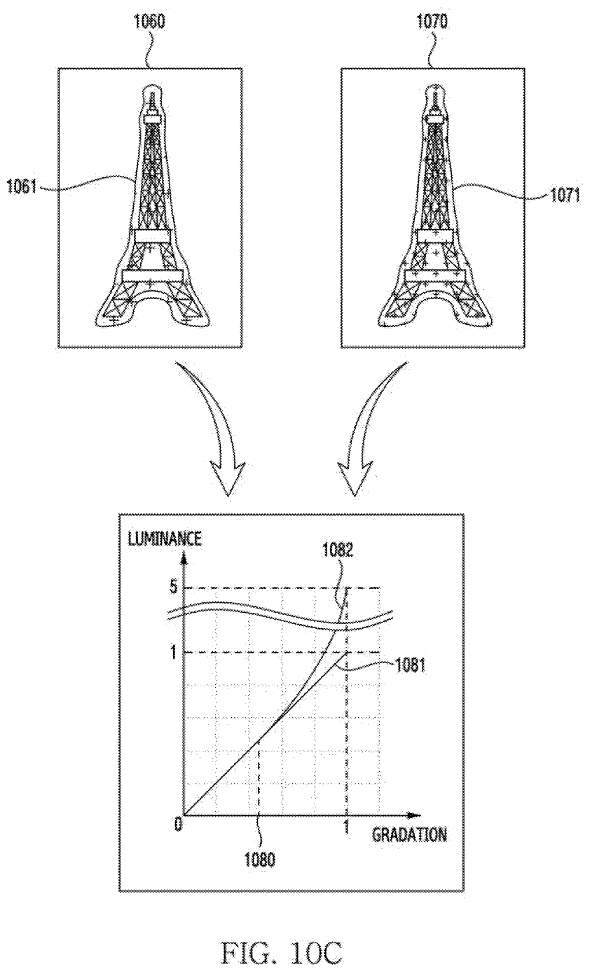

FIG. 10A illustrates an operation of an electronic device for changing a gradation range according to an embodiment of the disclosure.

FIG. 10B illustrates a change of an image according to a change of a gradation range according to an embodiment of the disclosure.

FIG. 10C illustrates a change of an image according to a change of a gradation range according to an embodiment of the disclosure.

Referring to FIG. 10A, in operation 1001, a processor 210 may obtain information regarding a single image. For example, the processor 210 may obtain information regarding the single image to determine a threshold gradation level.

According to an embodiment of the disclosure, the information regarding the single image may include a shooting mode (e.g., a portrait shooting mode, a food shooting mode, a night view shooting mode, or a text shooting mode) of the single image and/or information regarding an object included in the single image. For example, the processor 210 may identify metadata of the single image. The processor 210 may identify the shooting mode of the single image based on the metadata of the single image. For example, the processor 210 may identify the object (or at least one object) included in the single image. The processor 210 may identify information regarding the object included in the single image. As an example, the information regarding the object may include a characteristic of the object, a shooting environment of the object, and/or a type of the object.

In operation 1002, the processor 210 may determine the threshold gradation level. For example, the processor 210 may determine the threshold gradation level based on the information regarding the single image. The processor 210 may distinguish a first area and a second area by using the threshold gradation level. For example, the processor 210 may identify a gradation range exceeding the threshold gradation level as a first gradation range. The first area may have a gradation range (or the first gradation range) exceeding the threshold gradation level. The processor 210 may identify a gradation range equal to or less than the threshold gradation level as a third gradation range. The second area may have a gradation range (or the third gradation range) equal to or less than the threshold gradation level.

For example, the processor 210 may determine the threshold gradation level based on the shooting mode of the single image. In a case that the shooting mode of the single image is the food shooting mode, the processor 210 may set the threshold gradation level to a first threshold gradation level. In a case that the shooting mode of the single image is the night view shooting mode, the processor 210 may set the threshold gradation level to a second threshold gradation level greater than the first threshold gradation level. The processor 210 may determine the threshold gradation level according to the shooting mode of the single image. The first threshold gradation level and the second threshold gradation level described above are exemplary and are not limited thereto. According to an embodiment of the disclosure, in a case that the shooting mode of the single image is the night view shooting mode, the processor 210 may set the threshold gradation level to the second threshold gradation level less than or equal to the first threshold gradation level.

For example, the processor 210 may determine the threshold gradation level based on the information regarding the object included in the single image. The processor 210 may identify that food is included in the single image. The processor 210 may set the threshold gradation level to a first threshold gradation level based on identifying that the food is included in the single image. The processor 210 may set the threshold gradation level to a second threshold gradation level greater than the first threshold gradation level based on identifying that a building is included in the single image. The first threshold gradation level and the second threshold gradation level described above are exemplary and are not limited thereto. According to an embodiment of the disclosure, the processor 210 may set the threshold gradation level to the second threshold gradation level less than or equal to the first threshold gradation level based on identifying that the building is included in the single image.

In operation 1003, the processor 210 may obtain map information for changing a gradation range of the first area from the first gradation range to a second gradation range. For example, the operation 1003 may correspond to the operation 320 of FIG. 3.

For example, the processor 210 may determine the second gradation range based on the information regarding the single image. The processor 210 may obtain the map information for changing the gradation range of the first area from the first gradation range to the second gradation range based on the information regarding the single image.

For example, based on the shooting mode of the single image being the food shooting mode, the processor 210 may identify a second gradation range. For example, based on the shooting mode of the single image being the night view shooting mode, the processor 210 may identify a second gradation range. The second gradation range identified in the night view shooting mode may be distinguished from the second gradation range identified in the food shooting mode.

In operation 1004, the processor 210 may store a file including metadata including the map information and the single image. For example, the operation 1004 may correspond to the operation 330 of FIG. 3.

Referring to FIG. 10B, the processor 210 may obtain a first image 1010. The processor 210 may obtain information regarding the first image 1010. For example, the processor 210 may identify a shooting mode of the first image 1010 based on metadata of the first image 1010. The processor 210 may identify that the shooting mode of the first image 1010 is the food shooting mode.

According to an embodiment of the disclosure, the processor 210 may identify a threshold gradation level 1030 based on the shooting mode of the first image 1010. The processor 210 may identify an area corresponding to an object 1011 as a first area based on the threshold gradation level 1030. The processor 210 may identify an area excluding the area corresponding to the object 1011 as a second area.

According to an embodiment of the disclosure, the processor 210 may identify a second gradation range based on the shooting mode of the first image 1010. The processor 210 may obtain map information to visually highlight the first area (i.e., the area corresponding to the object 1011) for the second area. The processor 210 may change a gradation range of the first area from a first gradation range to the second gradation range wider than the first gradation range by using the map information. The processor 210 may obtain a second image 1020 based on the first image 1010 and the map information. Brightness levels regarding an object 1021 of the second image 1020 may be set to be greater than brightness levels regarding the object 1011 of the first image 1010.

A graph 1031 indicates a normalized luminance level according to a normalized gradation level regarding the first image 1010. A graph 1032 indicates a normalized luminance level according to a normalized gradation level regarding the second image 1020.

For example, in the first image 1010, in a case that the normalized gradation level is ‘1’, a normalized luminance level of a display 120 may be set to ‘1’. In the second image 1020, in a case that the normalized gradation level is ‘1’, the normalized luminance level of the display 120 may be set to ‘1.2’. As the second image 1020 is displayed through the display 120 instead of the first image 1010, the luminance level may be changed from ‘1’ to ‘1.2’. A ratio at which the luminance level is changed may be referred to as an SDR-to-HDR ratio.

Referring to FIG. 10C, the processor 210 may obtain a first image 1060. The processor 210 may obtain information regarding the first image 1060. For example, the processor 210 may identify a shooting mode of the first image 1060 based on metadata of the first image 1060. The processor 210 may identify that the shooting mode of the first image 1060 is the night view shooting mode.

According to an embodiment of the disclosure, the processor 210 may identify a threshold gradation level 1080 based on the shooting mode of the first image 1060. The processor 210 may identify an area corresponding to an object 1061 as a first area based on the threshold gradation level 1080. The processor 210 may identify an area excluding the area corresponding to the object 1061 as a second area. For example, the threshold gradation level 1080 may be set to be lower than the threshold gradation level 1030 of FIG. 10B.

According to an embodiment of the disclosure, the processor 210 may identify a second gradation range based on the shooting mode of the first image 1060. For example, the second gradation range identified based on the shooting mode of the first image 1060 may be distinguished from the second gradation range identified based on the shooting mode of the first image 1010 of FIG. 10B.

For example, the processor 210 may obtain map information to visually highlight the first area (i.e., the area corresponding to the object 1061) for the second area. The processor 210 may change a gradation range of the first area from a first gradation range to the second gradation range wider than the first gradation range by using the map information. The processor 210 may obtain a second image 1070 based on the first image 1060 and the map information. Brightness levels regarding an object 1071 of the second image 1070 may be set to be greater than brightness levels regarding the object 1061 of the first image 1060.

A graph 1081 indicates a normalized luminance level according to a normalized gradation level regarding the first image 1060. A graph 1082 indicates a normalized luminance level according to a normalized gradation level regarding the second image 1070.

For example, in the first image 1060, in a case that the normalized gradation level is ‘1’, a normalized luminance level of the display 120 may be set to ‘1’. In the second image 1070, in a case that the normalized gradation level is ‘1’, the normalized luminance level of the display 120 may be set to ‘5’. As the second image 1070 is displayed through the display 120 instead of the first image 1060, the luminance level may be changed from ‘1’ to ‘5’. A ratio at which the luminance level is changed may be referred to as an SDR-to-HDR ratio.

Referring to FIGS. 10B and 10C, a ratio at which a luminance level is changed may be set according to a first image (e.g., the first image 1010 or the first image 1060). The processor 210 may set the ratio at which the luminance level is changed based on information (e.g., a shooting mode of the first image or information regarding an object included in the first image) regarding the first image.

FIG. 11 is a block diagram illustrating an electronic device in a network environment according to an embodiment of the disclosure.

Referring to FIG. 11, an electronic device 1101 in a network environment 1100 may communicate with an external electronic device 1102 via a first network 1198 (e.g., a short-range wireless communication network), or at least one of an external electronic device 1104 or a server 1108 via a second network 1199 (e.g., a long-range wireless communication network). According to an embodiment of the disclosure, the electronic device 1101 may communicate with the external electronic device 1104 via the server 1108. According to an embodiment of the disclosure, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments of the disclosure, at least one of the components (e.g., the connecting terminal 1178) may be omitted from the electronic device 1101, or one or more other components may be added in the electronic device 1101. In some embodiments of the disclosure, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment of the disclosure, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment of the disclosure, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., a sleep) state, or together with the main processor 1121 while the main processor 1121 is in an active state (e.g., executing an application). According to an embodiment of the disclosure, the auxiliary processor 1123 (e.g., an image signal processor or a communication processor) may be implemented as part of another component (e.g., the camera module 1180 or the communication module 1190) functionally related to the auxiliary processor 1123. According to an embodiment of the disclosure, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment of the disclosure, the display module 1160 may include a touch sensor adapted to detect a touch, or a pressure sensor adapted to measure the intensity of force incurred by the touch.

The audio module 1170 may convert a sound into an electrical signal and vice versa. According to an embodiment of the disclosure, the audio module 1170 may obtain the sound via the input module 1150, or output the sound via the sound output module 1155 or a headphone of an external electronic device (e.g., the external electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment of the disclosure, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the external electronic device 1102) directly (e.g., wiredly) or wirelessly. According to an embodiment of the disclosure, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the external electronic device 1102). According to an embodiment of the disclosure, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 1179 may include, for example, a motor, a piezoelectric element, or an electric stimulator.

The camera module 1180 may capture a still image or moving images. According to an embodiment of the disclosure, the camera module 1180 may include one or more lenses, image sensors, image signal processors, or flashes.

The power management module 1188 may manage power supplied to the electronic device 1101. According to an embodiment of the disclosure, the power management module 1188 may be implemented as at least part of, for example, a power management integrated circuit (PMIC).

The battery 1189 may supply power to at least one component of the electronic device 1101. According to an embodiment of the disclosure, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the external electronic device 1102, the external electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment of the disclosure, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the millimeter wave (mmWave) band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the external electronic device 1104), or a network system (e.g., the second network 1199). According to an embodiment of the disclosure, the wireless communication module 1192 may support a peak data rate (e.g., 20 Gbps or more) for implementing eMBB, loss coverage (e.g., 1164 dB or less) for implementing mMTC, or user plane (U-plane) latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment of the disclosure, the antenna module 1197 may include an antenna including a radiating element including a conductive material or a conductive pattern formed in or on a substrate (e.g., a printed circuit board (PCB)). According to an embodiment of the disclosure, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment of the disclosure, another component (e.g., a radio frequency integrated circuit (RFIC)) other than the radiating element may be additionally formed as part of the antenna module 1197.

According to various embodiments of the disclosure, the antenna module 1197 may form a mmWave antenna module. According to an embodiment of the disclosure, the mm Wave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 1101 and the external electronic device 1104 via the server 1108 coupled with the second network 1199. Each of the external electronic devices 1102 or 1104 may be a device of a same type as, or a different type, from the electronic device 1101. According to an embodiment of the disclosure, all or some of operations to be executed at the electronic device 1101 may be executed at one or more of the external electronic devices 1102 or 1104, or the server 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment of the disclosure, the external electronic device 1104 may include an Internet-of-things (IoT) device. The server 1108 may be an intelligent server using machine learning and/or a neural network. According to an embodiment of the disclosure, the external electronic device 1104 or the server 1108 may be included in the second network 1199. The electronic device 1101 may be applied to intelligent services (e.g., a smart home, a smart city, a smart car, or healthcare) based on 5G communication technology or IoT-related technology.

FIG. 12 is a block diagram 1200 illustrating a camera module according to an embodiment of the disclosure.

Referring to FIG. 12, the camera module 1180 may include a lens assembly 1210, a flash 1220, an image sensor 1230, an image stabilizer 1240, memory 1250 (e.g., buffer memory), or an image signal processor 1260. The lens assembly 1210 may collect light emitted or reflected from an object whose image is to be taken. The lens assembly 1210 may include one or more lenses. According to an embodiment of the disclosure, the camera module 1180 may include a plurality of lens assemblies 1210. In such a case, the camera module 1180 may form, for example, a dual camera, a 360-degree camera, or a spherical camera. Some of the plurality of lens assemblies 1210 may have the same lens attribute (e.g., view angle, focal length, auto-focusing, f number, or optical zoom), or at least one lens assembly may have one or more lens attributes different from those of another lens assembly. The lens assembly 1210 may include, for example, a wide-angle lens or a telephoto lens.

The flash 1220 may emit light that is used to reinforce light reflected from an object. According to an embodiment of the disclosure, the flash 1220 may include one or more light emitting diodes (LEDs) (e.g., a red-green-blue (RGB) LED, a white LED, an infrared (IR) LED, or an ultraviolet (UV) LED) or a xenon lamp. The image sensor 1230 may obtain an image corresponding to an object by converting light emitted or reflected from the object and transmitted via the lens assembly 1210 into an electrical signal. According to an embodiment of the disclosure, the image sensor 1230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 1230 may be implemented using, for example, a charged coupled device (CCD) sensor or a complementary metal oxide semiconductor (CMOS) sensor.

The image stabilizer 1240 may move the image sensor 1230 or at least one lens included in the lens assembly 1210 in a particular direction, or control an operational attribute (e.g., adjust the read-out timing) of the image sensor 1230 in response to the movement of the camera module 1180 or the electronic device 1101 including the camera module 1180. This allows compensating for at least part of a negative effect (e.g., image blurring) by the movement on an image being captured. According to an embodiment of the disclosure, the image stabilizer 1240 may sense such a movement by the camera module 1180 or the electronic device 1101 using a gyro sensor (not shown) or an acceleration sensor (not shown) disposed inside or outside the camera module 1180. According to an embodiment of the disclosure, the image stabilizer 1240 may be implemented, for example, as an optical image stabilizer.

The memory 1250 may store, at least temporarily, at least part of an image obtained via the image sensor 1230 for a subsequent image processing task. For example, if image capturing is delayed due to shutter lag or multiple images are quickly captured, a raw image obtained (e.g., a Bayer-patterned image, a high-resolution image) may be stored in the memory 1250, and its corresponding copy image (e.g., a low-resolution image) may be previewed via the display module 1160. Thereafter, if a specified condition is met (e.g., by a user's input or system command), at least part of the raw image stored in the memory 1250 may be obtained and processed, for example, by the image signal processor 1260. According to an embodiment of the disclosure, the memory 1250 may be configured as at least part of the memory 1130 or as a separate memory that is operated independently from the memory 1130.

The image signal processor 1260 may perform one or more image processing with respect to an image obtained via the image sensor 1230 or an image stored in the memory 1250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 1260 may perform control (e.g., exposure time control or read-out timing control) with respect to at least one (e.g., the image sensor 1230) of the components included in the camera module 1180. An image processed by the image signal processor 1260 may be stored back in the memory 1250 for further processing, or may be provided to an external component (e.g., the memory 1130, the display module 1160, the external electronic device 1102, the external electronic device 1104, or the server 1108) outside the camera module 1180. According to an embodiment of the disclosure, the image signal processor 1260 may be configured as at least part of the processor 1120, or as a separate processor that is operated independently from the processor 1120. If the image signal processor 1260 is configured as a separate processor from the processor 1120, at least one image processed by the image signal processor 1260 may be displayed, by the processor 1120, via the display module 1160 as it is or after being further processed. According to an embodiment of the disclosure, the electronic device 1101 may include a plurality of camera modules 1180 having different attributes or functions. In such a case, at least one of the plurality of camera modules 1180 may form, for example, a wide-angle camera and at least another of the plurality of camera modules 1180 may form a telephoto camera. Similarly, at least one of the plurality of camera modules 1180 may form, for example, a front camera and at least another of the plurality of camera modules 1180 may form a rear camera.

FIG. 13 is a block diagram 1300 illustrating a display module according to an embodiment of the disclosure.

Referring to FIG. 13, the display module 1160 may include a display 1310 and a display driver integrated circuit (DDI) 1330 to control the display 1310. The DDI 1330 may include an interface module 1331, memory 1333 (e.g., buffer memory), an image processing module 1335, or a mapping module 1337. The DDI 1330 may receive image information that contains image data or an image control signal corresponding to a command to control the image data from another component of the electronic device 1101 via the interface module 1331. For example, according to an embodiment of the disclosure, the image information may be received from the processor 1120 (e.g., the main processor 1121 (e.g., an application processor)) or the auxiliary processor 1123 (e.g., a graphics processing unit) operated independently from the function of the main processor 1121. The DDI 1330 may communicate, for example, with touch circuitry 1350 or the sensor module 1176 via the interface module 1331. The DDI 1330 may also store at least part of the received image information in the memory 1333, for example, on a frame by frame basis. The image processing module 1335 may perform pre-processing or post-processing (e.g., adjustment of resolution, brightness, or size) with respect to at least part of the image data. According to an embodiment of the disclosure, the pre-processing or post-processing may be performed, for example, based at least in part on one or more characteristics of the image data or one or more characteristics of the display 1310. The mapping module 1337 may generate a voltage value or a current value corresponding to the image data pre-processed or post-processed by the image processing module 1335. According to an embodiment of the disclosure, the generating of the voltage value or current value may be performed, for example, based at least in part on one or more attributes of the pixels (e.g., an array, such as an RGB stripe or a pentile structure, of the pixels, or the size of each subpixel). At least some pixels of the display 1310 may be driven, for example, based at least in part on the voltage value or the current value such that visual information (e.g., a text, an image, or an icon) corresponding to the image data may be displayed via the display 1310.

According to an embodiment of the disclosure, the display module 1160 may further include the touch circuitry 1350. The touch circuitry 1350 may include a touch sensor 1351 and a touch sensor IC 1353 to control the touch sensor 1351. The touch sensor IC 1353 may control the touch sensor 1351 to sense a touch input or a hovering input with respect to a certain position on the display 1310. To achieve this, for example, the touch sensor 1351 may detect (e.g., measure) a change in a signal (e.g., a voltage, a quantity of light, a resistance, or a quantity of one or more electric charges) corresponding to the certain position on the display 1310. The touch circuitry 1350 may provide input information (e.g., a position, an area, a pressure, or a time) indicative of the touch input or the hovering input detected via the touch sensor 1351 to the processor 1120. According to an embodiment of the disclosure, at least part (e.g., the touch sensor IC 1353) of the touch circuitry 1350 may be formed as part of the display 1310 or the DDI 1330, or as part of another component (e.g., the auxiliary processor 1123) disposed outside the display module 1160.

According to an embodiment of the disclosure, the display module 1160 may further include at least one sensor (e.g., a fingerprint sensor, an iris sensor, a pressure sensor, or an illuminance sensor) of the sensor module 1176 or a control circuit for the at least one sensor. In such a case, the at least one sensor or the control circuit for the at least one sensor may be embedded in one portion of a component (e.g., the display 1310, the DDI 1330, or the touch circuitry 1350)) of the display module 1160. For example, when the sensor module 1176 embedded in the display module 1160 includes a biometric sensor (e.g., a fingerprint sensor), the biometric sensor may obtain biometric information (e.g., a fingerprint image) corresponding to a touch input received via a portion of the display 1310. As another example, when the sensor module 1176 embedded in the display module 1160 includes a pressure sensor, the pressure sensor may obtain pressure information corresponding to a touch input received via a partial or whole area of the display 1310. According to an embodiment of the disclosure, the touch sensor 1351 or the sensor module 1176 may be disposed between pixels in a pixel layer of the display 1310, or over or under the pixel layer.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added. The electronic device 1101 of FIG. 11 may be an example of the electronic device 101 of FIGS. 1, 2, 3, 4, 5, 6, 7A, 7B, 7C, 8, 9A, 9B, 10A, 10B, and 10C.

The technical problems to be achieved in this document are not limited to those described above, and other technical problems not mentioned herein will be clearly understood by those having ordinary knowledge in the art to which the disclosure belongs, from the following description.

According to an embodiment of the disclosure, an electronic device (e.g., the electronic device 101 of FIGS. 1, 2, 3, 4, 5, 6, 7A, 7B, 7C, 8, 9A, 9B, 10A, 10B, and 10C or the electronic device 1101 of FIG. 11) may comprise a display (e.g., the display 120 or the display module 1160 of FIG. 11), at least one processor (e.g., the processor 210 of FIGS. 1, 2, 3, 4, 5, 6, 7A, 7B, 7C, 8, 9A, 9B, 10A, 10B, and 10C or the processor 1120 of FIG. 11) including processing circuitry, and memory (e.g., the memory 215 of FIGS. 1, 2, 3, 4, 5, 6, 7A, 7B, 7C, 8, 9A, 9B, 10A, 10B, and 10C or the memory 1130 of FIG. 11) comprising one or more storage media storing instructions. The instructions, when executed individually or collectively by the at least one processor, may cause the electronic device to, based on a predetermined event, obtain a single image (e.g., the first image 130 of FIG. 4). The instructions, when executed individually or collectively by the at least one processor, may cause the electronic device to, when the single image is displayed for a first area of the single image that is visually highlighted for a second area of the single image, obtain map information (e.g., the map information 140 of FIG. 4) from the single image for changing a gradation range of the first area from a first gradation range to a second gradation range wider than the first gradation range. The instructions, when executed individually or collectively by the at least one processor, may cause the electronic device to store a file including metadata including the map information and the single image, in the memory.

According to an embodiment of the disclosure, the instructions, when executed individually or collectively by the at least one processor, may cause the electronic device to determine, based on setting information regarding the single image, at least one gradation level. The instructions, when executed individually or collectively by the at least one processor, may cause the electronic device to identify the first area and the second area within the single image based on the at least one gradation level.

According to an embodiment of the disclosure, the setting information regarding the single image may comprise at least one of information regarding at least one camera for obtaining the single image, a shooting mode regarding the single image, or information regarding at least one object included in the single image.

According to an embodiment of the disclosure, the at least one gradation level may include a threshold gradation level. The instructions, when executed individually or collectively by the at least one processor, may cause the electronic device to identify a gradation range exceeding the threshold gradation level as the first gradation range.

According to an embodiment of the disclosure, the instructions, when executed individually or collectively by the at least one processor, may cause the electronic device to obtain a gain image (e.g., the gain image 121 of FIG. 4) including the first area by removing the second area from the single image. The instructions, when executed individually or collectively by the at least one processor, may cause the electronic device to obtain, based on the gain image, the map information.

According to an embodiment of the disclosure, the instructions, when executed individually or collectively by the at least one processor, may cause the electronic device to remove distortion of at least one object included in the gain image using a designated algorithm. The instructions, when executed individually or collectively by the at least one processor, may cause the electronic device to obtain the map information based on the gain image from which the distortion is removed.

According to an embodiment of the disclosure, the instructions, when executed individually or collectively by the at least one processor, may cause the electronic device to obtain, based on reducing brightness levels of the gain image, a first processing image. The instructions, when executed individually or collectively by the at least one processor, may cause the electronic device to obtain, based on performing a calibration on the first processing image, a second processing image. The instructions, when executed individually or collectively by the at least one processor, may cause the electronic device to remove, based on increasing brightness levels of the second processing image, the distortion of the at least one object included in the gain image.

According to an embodiment of the disclosure, the instructions, when executed individually or collectively by the at least one processor, may cause the electronic device to apply a designated filter to the gain image. The instructions, when executed individually or collectively by the at least one processor, may cause the electronic device to obtain the map information based on the gain image to which the designated filter is applied.

According to an embodiment of the disclosure, the instructions, when executed individually or collectively by the at least one processor, may cause the electronic device to remove the distortion of the at least one object included in the gain image while maintaining an outline of the at least one object included in the gain image, by applying the designated filter to the gain image.

According to an embodiment of the disclosure, the instructions, when executed individually or collectively by the at least one processor, may cause the electronic device to identify that a designated object (e.g., the designated object 901 of FIG. 9B) is included within the single image. The instructions, when executed individually or collectively by the at least one processor, may cause the electronic device to reduce the second gradation range based on identifying that the designated object is included within the single image.

According to an embodiment of the disclosure, the electronic device may comprise at least one camera. The predetermined event may comprise an event for obtain a plurality of images using the at least one camera. The single image may be obtained based on the plurality of images.

According to an embodiment of the disclosure, the instructions, when executed individually or collectively by the at least one processor, may cause the electronic device to identify a brightness value of the display based on the metadata and the single image included in the file. The instructions, when executed individually or collectively by the at least one processor, may cause the electronic device to, for displaying the single image, display another image configured based on the metadata and the single image, using the display providing brightness according to the brightness value.

According to an embodiment of the disclosure, a method performed by an electronic device (e.g., the electronic device 101 of FIGS. 1, 2, 3, 4, 5, 6, 7A, 7B, 7C, 8, 9A, 9B, 10A, 10B, and 10C or the electronic device 1101 of FIG. 11) comprising a display (e.g., the display 120 or the display module 1160 of FIG. 11) may comprise, based on a predetermined event, obtaining a single image (e.g., the first image 130 of FIG. 4). The method may comprise, when the single image is displayed for a first area of the single image that is visually highlighted for a second area of the single image, obtaining map information (e.g., the map information 140 of FIG. 4) from the single image for changing a gradation range of the first area from a first gradation range to a second gradation range wider than the first gradation range. The method may comprise storing a file including metadata including the map information and the single image, in the memory (e.g., the memory 215 of FIGS. 1, 2, 3, 4, 5, 6, 7A, 7B, 7C, 8, 9A, 9B, 10A, 10B, and 10C or the memory 1130 of FIG. 11).

According to an embodiment of the disclosure, the method may comprise determining, based on setting information regarding the single image, at least one gradation level. The method may comprise identifying the first area and the second area within the single image based on the at least one gradation level.

According to an embodiment of the disclosure, the setting information regarding the single image may comprise at least one of information regarding at least one camera for obtaining the single image, a shooting mode regarding the single image, or information regarding at least one object included in the single image.

According to an embodiment of the disclosure, the at least one gradation level may include a threshold gradation level. The method may comprise identifying a gradation range exceeding the threshold gradation level as the first gradation range.

According to an embodiment of the disclosure, the method may comprise obtaining a gain image including the first area by removing the second area from the single image. The method may comprise obtaining, based on the gain image, the map information.

According to an embodiment of the disclosure, the method may comprise removing distortion of at least one object included in the gain image using a designated algorithm. The method may comprise obtaining the map information based on the gain image from which the distortion is removed.

According to an embodiment of the disclosure, the method may comprise obtaining, based on reducing brightness levels of the gain image, a first processing image. The method may comprise obtaining, based on performing a calibration on the first processing image, a second processing image. The method may comprise removing, based on increasing brightness levels of the second processing image, the distortion of the at least one object included in the gain image.

According to an embodiment of the disclosure, the method may comprise applying a designated filter to the gain image. The method may comprise obtaining the map information based on the gain image to which the designated filter is applied.

According to an embodiment of the disclosure, the method may comprise removing the distortion of the at least one object included in the gain image while maintaining an outline of the at least one object included in the gain image, by applying the designated filter to the gain image.

According to an embodiment of the disclosure, the method may comprise identifying that a designated object is included within the single image. The method may comprise reducing the second gradation range based on identifying that the designated object is included within the single image.

According to an embodiment of the disclosure, the electronic device may comprise at least one camera. The predetermined event may comprise an event for obtain a plurality of images using the at least one camera. The single image may be obtained based on the plurality of images.

According to an embodiment of the disclosure, the method may comprise identifying a brightness value of the display based on the metadata and the single image included in the file. The method may comprise, for displaying the single image, displaying another image configured based on the metadata and the single image, using the display providing brightness according to the brightness value.

According to an embodiment of the disclosure, a non-transitory computer readable storage medium may store one or more programs. The one or more programs may comprise instructions to, when executed by a processor of an electronic device, cause the electronic device to, based on a predetermined event, obtain a single image. The one or more programs may comprise instructions to, when executed by the processor of the electronic device, cause the electronic device to, when the single image is displayed for a first area of the single image that is visually highlighted for a second area of the single image, obtain map information from the single image for changing a gradation range of the first area from a first gradation range to a second gradation range wider than the first gradation range. The one or more programs may comprise instructions to, when executed by the processor of the electronic device, cause the electronic device to store a file including metadata including the map information and the single image, in the memory.

According to the above-described embodiment of the disclosure, an electronic device may generate a gain map from a single exposure image. The electronic device may improve luminance of a display based on the gain map (or map information). The electronic device may provide an HDR experience by improving the luminance of the display based on the gain map. Accordingly, the electronic device may obtain the gain map from an existing legacy SDR image and generate an image having an HDR effect by using the obtained gain map. The electronic device may display the image having the HDR effect through the display.

The effects that can be obtained from the disclosure are not limited to those described above, and any other effects not mentioned herein will be clearly understood by those having ordinary knowledge in the art to which the disclosure belongs, from the following description.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium, such as hard disk, floppy disk, and magnetic tape, optical recording medium, such as CD-ROM and digital versatile disc (DVD), magneto-optical medium, such as floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What claimed is:

1. An electronic device comprising:
a display;
memory, comprising one or more storage media, storing instructions; and
at least one processor including processing circuitry,
wherein the instructions, when executed by the at least one processor individually or collectively, cause the electronic device to:
based on a predetermined event, obtain a single image,
when the single image is displayed for a first area of the single image that is visually highlighted for a second area of the single image, obtain map information from the single image for changing a gradation range of the first area from a first gradation range to a second gradation range wider than the first gradation range, and
store a file including metadata including the map information and the single image, in the memory.

2. The electronic device of claim 1, wherein the instructions, when executed by the at least one processor individually or collectively, further cause the electronic device to:
determine, based on setting information regarding the single image, at least one gradation level, and
identify the first area and the second area within the single image based on the at least one gradation level.

3. The electronic device of claim 2, wherein the setting information regarding the single image comprises at least one of:
information regarding at least one camera for obtaining the single image;
a shooting mode regarding the single image; or
information regarding at least one object included in the single image.

4. The electronic device of claim 2,
wherein the at least one gradation level includes a threshold gradation level, and
wherein the instructions, when executed by the at least one processor individually or collectively, further cause the electronic device to identify a gradation range exceeding the threshold gradation level as the first gradation range.

5. The electronic device of claim 1, wherein the instructions, when executed by the at least one processor individually or collectively, further cause the electronic device to:
obtain a gain image including the first area by removing the second area from the single image, and
obtain, based on the gain image, the map information.

6. The electronic device of claim 5, wherein the instructions, when executed by the at least one processor individually or collectively, further cause the electronic device to:
remove distortion of at least one object included in the gain image using a designated algorithm, and
obtain the map information based on the gain image from which the distortion is removed.

7. The electronic device of claim 6, wherein the instructions, when executed by the at least one processor individually or collectively, further cause the electronic device to:
obtain, based on reducing brightness levels of the gain image, a first processing image,
obtain, based on performing a calibration on the first processing image, a second processing image, and
remove, based on increasing brightness levels of the second processing image, the distortion of the at least one object included in the gain image.

8. The electronic device of claim 6, wherein the instructions, when executed by the at least one processor individually or collectively, further cause the electronic device to:
apply a designated filter to the gain image, and
obtain the map information based on the gain image to which the designated filter is applied.

9. The electronic device of claim 8, wherein the instructions, when executed by the at least one processor individually or collectively, further cause the electronic device to:
remove the distortion of the at least one object included in the gain image while maintaining an outline of the at least one object included in the gain image, by applying the designated filter to the gain image.

10. The electronic device of claim 1, wherein the instructions, when executed by the at least one processor individually or collectively, further cause the electronic device to:
identify that a designated object is included within the single image, and reduce the second gradation range based on identifying that the designated object is included within the single image.

11. The electronic device of claim 1,
wherein the electronic device comprises at least one camera,
wherein the predetermined event comprises an event for obtain a plurality of images using the at least one camera, and
wherein the single image is obtained based on the plurality of images.

12. The electronic device of claim 1, wherein the instructions, when executed by the at least one processor individually or collectively, further cause the electronic device to:
identify a brightness value of the display based on the metadata and the single image included in the file, and
for displaying the single image, display another image configured based on the metadata and the single image, using the display providing brightness according to the brightness value.

13. A method performed by an electronic device comprising a display, the method comprising:
based on a predetermined event, obtaining a single image;
when the single image is displayed for a first area of the single image that is visually highlighted for a second area of the single image, obtaining map information from the single image for changing a gradation range of the first area from a first gradation range to a second gradation range wider than the first gradation range; and
storing a file including metadata including the map information and the single image, in memory.

14. The method of claim 13, further comprising:
determining, based on setting information regarding the single image, at least one gradation level; and
identifying the first area and the second area within the single image based on the at least one gradation level.

15. The method of claim 14, wherein the setting information regarding the single image comprises at least one of:
information regarding at least one camera for obtaining the single image;
a shooting mode regarding the single image; or
information regarding at least one object included in the single image.

16. The method of claim 14,
wherein the at least one gradation level includes a threshold gradation level, and
wherein the method further comprises identifying a gradation range exceeding the threshold gradation level as the first gradation range.

17. The method of claim 13, further comprising:
obtaining a gain image including the first area by removing the second area from the single image; and
obtaining, based on the gain image, the map information.

18. The method of claim 17, further comprising:
removing distortion of at least one object included in the gain image using a designated algorithm; and
obtaining the map information based on the gain image from which the distortion is removed.

19. One or more non-transitory computer-readable storage media storing one or more computer programs including computer-executable instructions that, when executed by at least one processor of an electronic device with a display individually or collectively, cause the electronic device to perform operations, the operations comprising:
based on a predetermined event, obtaining a single image;
when the single image is displayed for a first area of the single image that is visually highlighted for a second area of the single image, obtaining map information from the single image for changing a gradation range of the first area from a first gradation range to a second gradation range wider than the first gradation range; and
storing a file including metadata including the map information and the single image, in memory.

20. The one or more non-transitory computer-readable storage media of claim 19, the operations further comprising:
determining, based on setting information regarding the single image, at least one gradation level; and
identifying the first area and the second area within the single image based on the at least one gradation level.
